(19) United States
(12) Patent Application Publication
(10) Pub. No.: US 2026/0040229 A1
(43) Pub. Date: Feb. 5, 2026

(54) SEPARATE POWER CONTROL INCLUDING TRANSMIT POWER CONTROL (TPC) ACCUMULATORS ACROSS FULL DUPLEX (FD) AND NON-FD SYMBOLS

(71) Applicant: InterDigital Patent Holdings, Inc., Wilmington, DE (US)

(72) Inventors: Jonghyun Park, Syosset, NY (US); Nazli Khan Beigi, Longueuil (CA); Moon IL Lee, Melville, NY (US); Paul Marinier, Brossard (CA); Aata El Hamss, Laval (CA); Virgile Garcia, Antibes (FR)

(73) Assignee: InterDigital Patent Holdings, Inc., Wilmington, DE (US)

(21) Appl. No.: 18/793,246

(22) Filed: Aug. 2, 2024

(51) Int. Cl. H04W 52/14; H04L 5/14; H04W 52/08; H04W 52/10; H04W 72/1268

(52) U.S. Cl. CPC H04W 52/146; H04L 5/14; H04W 52/08; H04W 52/10; H04W 72/1268

(57) ABSTRACT

The present disclosure provides a wireless transmit/receive unit (WTRU) that maintains first and second transmit power control (TPC) accumulators. The WTRU receives, from a base station, a configuration including first and second sets of power control (PC) parameters associated with the first and second TPC accumulators, respectively. The WTRU receives a first TPC command, associated with the first TPC accumulator, from the base station. The WTRU updates the first TPC accumulator and the second TPC accumulator based on the first TPC command if the second TPC accumulator is dependent on the first TPC accumulator. The WTRU may maintain multiple TPC accumulators and may implement different TPC processes for different TPC accumulators. The different TPC accumulators may be associated with different symbol types. Hence, the WTRU may dynamically transmit one or more uplink channels and/or one or more uplink signals at different transmit power levels by utilizing corresponding TPC accumulators.

### BACKGROUND

In fifth generation (5G) wireless communication networks, a dynamic time division duplexing (TDD) is used to improve a spectral efficiency and satisfy increasing demand of low latency and/or high bandwidth applications. In the dynamic TDD, an uplink (UL) direction and a downlink (DL) direction are dynamically changed and/or switched. However, such a dynamic change and/or switch in the UL and/or DL directions introduces interferences such as cross-link interference (CLI) at base stations (gNBs) and user equipments (UEs). The CLI includes DL-to-UL interference (e.g., gNB-to-gNB interference) and/or UL-to-DL interference (e.g. UE-to-UE interference). In that, the CLI is much higher for full duplex (FD) symbols (e.g. sub-band non-overlapping full duplex (SBFD) symbols). Therefore, there is a need for a power control technique to address the CLI faced in the FD and/or dynamic TDD communication in the wireless communication networks.

### SUMMARY

In an embodiment, a method performed by a wireless transmit/receive unit (WTRU) is provided. The method includes receiving configuration information from a base station. The configuration information includes a first set of parameters associated with a first transmit power control (TPC) accumulator and a second set of parameters associated with a second TPC accumulator. The second TPC accumulator is dependent on the first TPC accumulator. The method further includes receiving, from the base station, a first TPC command associated with the first TPC accumulator. The method further includes updating the first TPC accumulator and the second TPC accumulator based on the first TPC command.

In an embodiment, a WTRU is provided. The WTRU includes a memory, a transceiver, and a processor. The memory is configured to store a first TPC accumulator and a second TPC accumulator. The transceiver is configured to receive, from a base station, configuration information including a first set of parameters associated with the first TPC accumulator and a second set of parameters associated with the second TPC accumulator. The second TPC accumulator is dependent on the first TPC accumulator. The transceiver is further configured to receive, from the base station, a first TPC command associated with the first TPC accumulator. The processor is configured to update the first TPC accumulator and the second TPC accumulator based on the first TPC command.

In an embodiment, the second TPC accumulator is associated with a sub-band full duplex (SBFD) transmission and the first TPC accumulator is associated with a non-SBFD transmission.

In an embodiment, the WTRU receives a second TPC command associated with the second TPC accumulator. The WTRU updates the second TPC accumulator based on the second TPC command.

In an example, the WTRU may receive an indication that the second TPC accumulator is dependent on the first TPC accumulator. In an example, the WTRU may determine that the second TPC accumulator is dependent on the first TPC accumulator.

In an embodiment, the WTRU updates the first TPC accumulator by incrementing a first accumulation level associated with the first TPC accumulator by a first value indicated by the first TPC command.

In an embodiment, the WTRU updates the second TPC accumulator by incrementing a second accumulation level associated with the second TPC accumulator by one or more of: the first value indicated by the first TPC command or a second value indicated by the second TPC command.

In an embodiment, the WTRU maintains the first TPC accumulator at the first accumulation level upon receiving the second TPC command.

In an embodiment, the WTRU initializes the first and second TPC accumulators to a common initial accumulation level.

In an embodiment, a first step-size associated with a first TPC command is different from a second step-size associated with a second TPC command.

In an embodiment, the first set of parameters and the second set of parameters comprise one or more common open loop power control parameters.

In an embodiment, the first set of parameters and the second sets of parameters comprise respective first and second closed loop indexes associated with the first and second TPC accumulators.

In an embodiment, the first TPC command and the second TPC command comprise respective first and second closed loop indexes associated with the first and second TPC accumulators.

In an embodiment, on a condition that an uplink grant scheduling an uplink channel transmission on one or more SBFD symbols is received from the base station, the WTRU determines a transmit power level based on the second TPC accumulator. The WTRU transmits, to the base station, the uplink channel transmission on the one or more SBFD symbols at the determined transmit power level.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example sub-band non-overlapping full duplex (SBFD) configuration in a time division duplex (TDD) framework according to an embodiment;

FIG. 3 is a diagram illustrating an example cross-link interference (CLI) in a network according to an embodiment;

FIG. 4 is a diagram illustrating an example downlink control information (DCI) field according to an embodiment;

FIG. 5 is a diagram illustrating an example transmission configuration indicator (TCI) and/or beam control across one or more full duplex (FD) and/or one or more non-FD symbols according to an embodiment;

FIG. 6 is a diagram illustrating one or more example power accumulation levels of a reference transmit power control (TPC) accumulator and/or a dependent TPC accumulator according to an embodiment; and

FIG. 7 is a flowchart illustrating an example process for updating separate TPC buffers according to an embodiment.

### DETAILED DESCRIPTION

As discussed herein, one or more abbreviations in the following (non-exhaustive) list, shown in Table 1, may be used herein.

TABLE 1

| | |
|---|---|
| CG | Configured Grant |
| DG | Dynamic Grant |
| MAC CE | MAC Control Element |
| ACK | Acknowledgement |
| BLER | Block Error Rate |
| BWP | Bandwidth Part |
| C-JT | Coherent Joint Transmission |
| CP | Cyclic Prefix |
| CP-OFDM | Conventional OFDM |
| | (relying on cyclic prefix) |
| CQI | Channel Quality Indicator |
| CRC | Cyclic Redundancy Check |
| CSI | Channel State Information |
| DAI | Downlink Assignment Index |
| DCI | Downlink Control Information |
| DL | Downlink |
| DM-RS | Demodulation Reference Signal |
| DRB | Data Radio Bearer |
| HARQ | Hybrid Automatic Repeat Request |
| LTE | Long Term Evolution |
| | E.G. from 3GPP LTE R8 and up |
| NACK | Negative ACK |
| mTRP | Multiple TRP |
| MCS | Modulation And Coding Scheme |
| MIMO | Multiple Input Multiple Output |
| NC-JT | Non-Coherent Joint Transmission |
| NR | New Radio |
| OFDM | Orthogonal Frequency-Division Multiplexing |
| PHY | Physical Layer |
| PMI | Precoding Matrix Indicator |
| PRACH | Physical Random Access Channel |
| PSS | Primary Synchronization Signal |
| RACH | Random Access Channel |
| | (and/or Random Access Procedure) |
| RAR | Random Access Response |
| RF | Radio Front End |
| RLF | Radio Link Failure |
| RLM | Radio Link Monitoring |
| RNTI | Radio Network Identifier |
| RRC | Radio Resource Control |
| RRM | Radio Resource Management |
| RS | Reference Signal |
| RSRP | Reference Signal Received Power |
| RSSI | Received Signal Strength Indicator |
| SDU | Service Data Unit |
| SRS | Sounding Reference Signal |
| SS | Synchronization Signal |
| SSS | Secondary Synchronization Signal |
| SPS | Semi-Persistent Scheduling |
| SUL | Supplemental Uplink |
| TB | Transport Block |
| TBS | Transport Block Size |
| TRP | Transmission/Reception Point |
| UL | Uplink |
| URLLC | Ultra-Reliable And Low Latency Communications |
| WLAN | Wireless Local Area Networks |
| | and related technologies (IEEE 802.XX Domain) |
| TDD | Time Division Duplex |
| XDD | Cross Division Duplex |
| FD | Full Duplex |
| HD | Half Duplex |
| IAB | Integrated Access And Backhaul |
| SI | Self-Interference |
| CLI | Cross-Link Interference |
| PDSCH | Physical Downlink Shared Channel |
| PUSCH | Physical Uplink Shared Channel |
| PDCCH | Physical Downlink Control Channel |
| PUCCH | Physical Uplink Control Channel |
| CORESET | Control Resource Set |
| SRS | Sounding Reference Signal |
| UE | User Equipment |
| PC | Power Control |
| RB | Resource Block |
| L1-RSRP | Layer1-RSRP |
| cri-RSRP | CSI-RS Resource Indicator-RSRP |
| SSB | Synchronization Signal Block |
| SINR | Signal-To-Interference-Plus-Noise Ratio |
| TCI | Transmission Configuration Indicator |
| OLPC | Open Loop Power Control |
| CLPC | Closed Loop Power Control |
| PL | Pathloss |
| P-MPR | Power Management-Maximum Power Reduction |
| PH | Power Headroom |
| PHR | Power Headroom Reporting |
| UCI | Uplink Control Information |
| SRI | SRS Resource Indicator |
| SL | Sidelink (Side Link) |
| CRS | Cell-Specific RS |

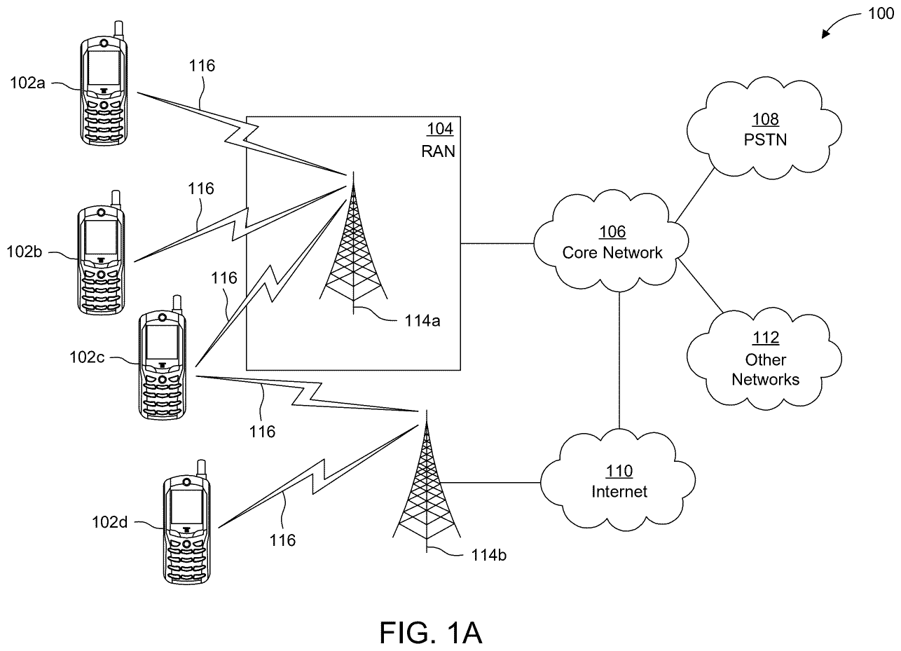

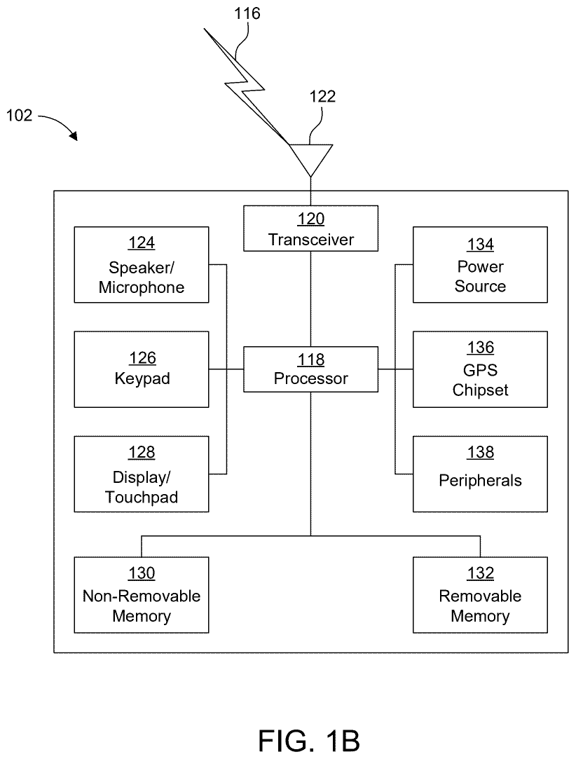

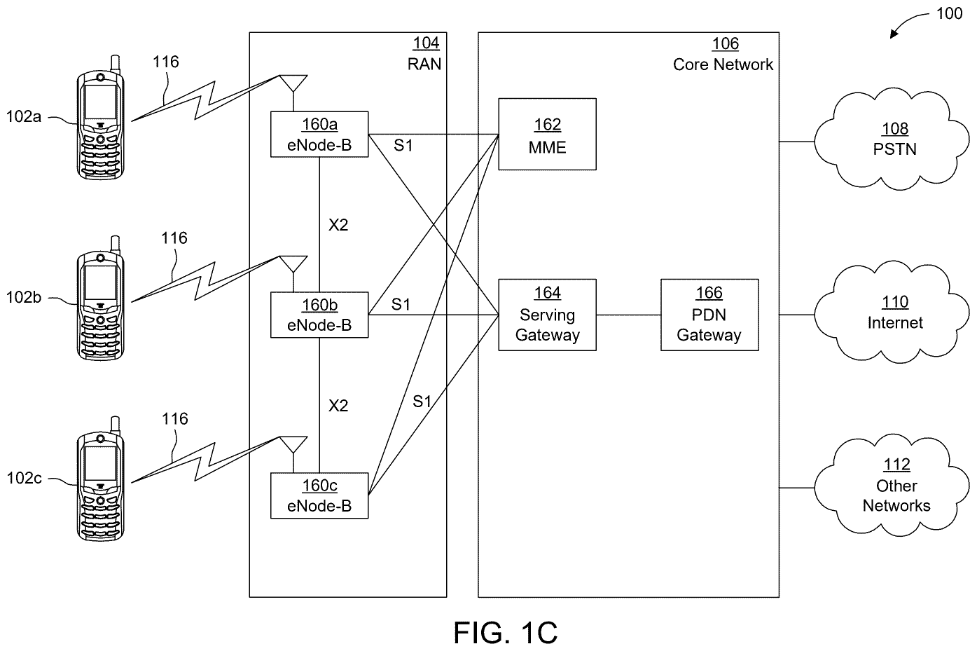

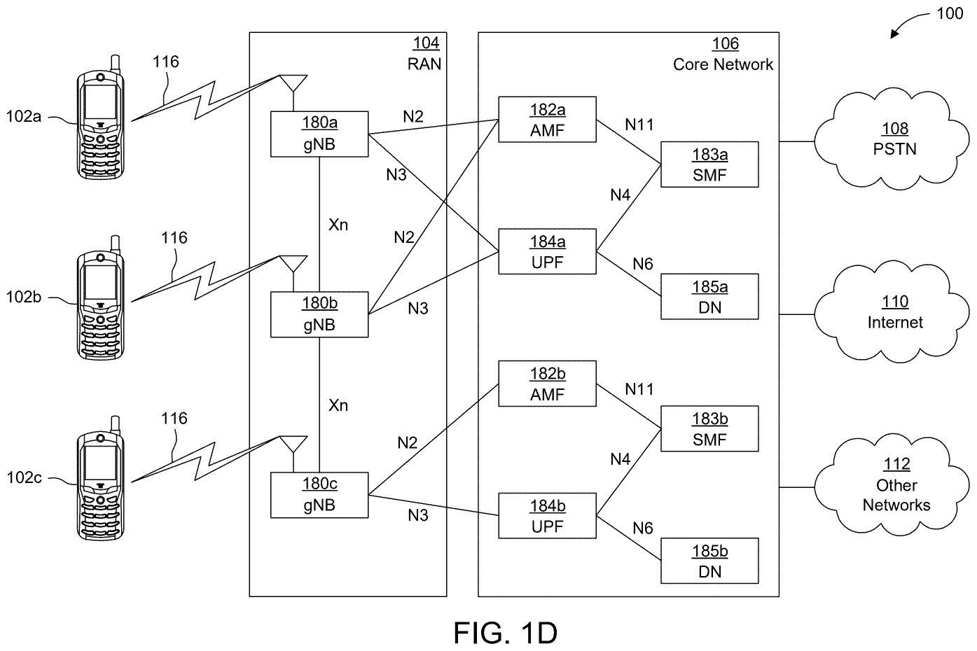

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In an embodiment, the present methods, systems, and apparatuses relate generally to new radio (NR) communication, for example duplex communication. A technique for separate power control including one or more transmit power control (TPC) accumulators across different symbol types is provided. In an example, one or more dependent TPC accumulators are used in association with one or more reference TPC accumulators. In an example, a technique for dynamic TPC accumulator resetting for the one or more dependent TPC accumulators is used in relation to one or more current values (e.g. one or more accumulation levels etc.) of the corresponding one or more reference TPC accumulators. In one or more use cases, one or more power control (PC) settings may be associated with one or more beam references (e.g., one or more transmission configuration indicator (TCI) states etc.).

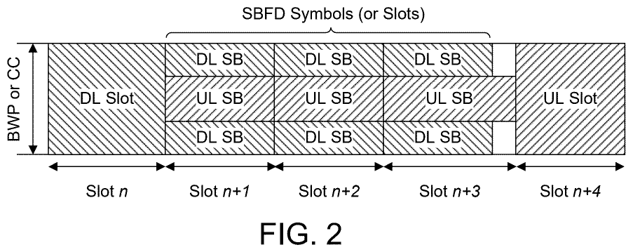

FIG. 2 is a diagram illustrating an example sub-band non-overlapping full duplex (SBFD) configuration in a time division duplex (TDD) framework according to an embodiment. In radio access network (RAN), RAN #102, a RAN work item on an NR duplex operation is agreed. The NR duplex operation may provide an improvement over a conventional TDD operation by enhancing an uplink (UL) coverage, improving capacity, and/or reducing latency etc., for example. The conventional TDD operation may be based on splitting a time domain between uplink and downlink. In NR Rel-19, feasibility of allowing a full duplex, or more specifically, the SBFD at the gNB within the conventional TDD band is illustrated in FIG. 2.

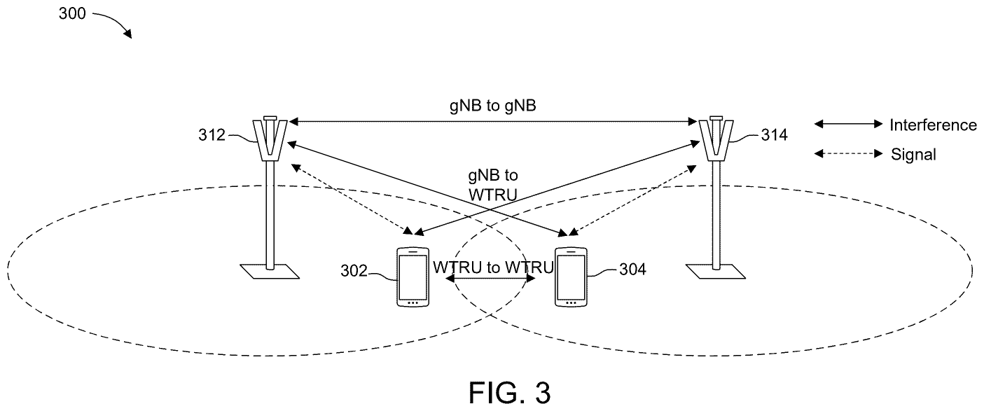

FIG. 3 is a diagram illustrating an example cross-link interference (CLI) in a network 300 according to an embodiment. The network 300 includes a first WTRU 302, a second WTRU 304, a first gNB 312, and a second gNB 314. A realization of the SBFD is subject to resolving one or more key challenges raised due to the CLI. In an SBFD framework, a dynamic TDD framework and/or a flexible TDD framework etc., for example, a potential aggressor cell may switch from the UL to the DL and/or vice-versa, thereby causing the CLI on one or more potential victim gNBs and/or WTRUs. In a UL-to-DL CLI, the UL transmission from one or more aggressor WTRUs (e.g. the first WTRU 302) may cause a directional CLI at the one or more victim WTRUs (e.g. the second WTRU 304), as shown in FIG. 2. The CLI may be measured at the victim and/or aggressor WTRUs (e.g. the first WTRU 302 and/or the second WTRU 304).

In an embodiment, a technique for managing power control for full duplex (FD) (e.g., the SBFD) and/or non-FD (e.g., the non-SBFD) symbols efficiently is provided, for instance, when the interference may be higher in the FD (e.g., the SBFD) symbols than the non-FD (e.g., the non-SBFD) symbols. In an example, one or more dependent TPC accumulators in association with the one or more reference TPC accumulators are provided.

In an embodiment, the WTRU may maintain one or more separate TPC accumulators for determining transmit power for transmissions in one or more non-SBFD symbols and/or one or more SBFD symbols. The one or more TPC accumulators for the one or more SBFD symbols may be updated based on one or more TPC commands targeting the one or more non-SBFD TPC accumulators as well as one or more TPC commands targeting the one or more SBFD TPC accumulators. This enables control of the transmit power in the one or more SBFD symbols based on one or more channel conditions that may apply to both types of symbols as well as the interference that may only apply to the one or more SBFD symbols.

In an embodiment, a WTRU receives a configuration including a first set of PC parameters and a second set of PC parameters. The first set of PC parameters (e.g., for use in the one or more non-SBFD symbols) may comprise but are not limited to at least one of P0, P_offset, alpha, a pathloss (PL) RS, and/or a first closed loop (CL) index (i.e. CL-index #1) etc., for example. The first CL index (i.e. the CL-index #1) may be associated with a first TPC accumulator. The first TPC accumulator may have an initial value of n1. That is, the first TPC accumulator may be initialized with an initial accumulation level of n1.

The WTRU determines a UL transmit (Tx) power level (P) based on the first set of PC parameters, e.g., at a given time i,

P(i)=P0+P_offset (i)+alpha*PL(i) (estimated by the PL RS)+a value of the first TPC accumulator (with the initial value of n1) associated with the CL-index #1.

In an embodiment, a second set of PC parameters (e.g., for use in the one or more SBFD symbols) may comprise but are not limited to at least one of P0, P_offset, alpha, the PL RS, a second CL index (i.e. CL-index #2) etc., for example. The second CL index (i.e. the CL-index #2) may be associated with a second TPC accumulator. The second TPC accumulator may have an initial value of n2. That is, the second TPC accumulator may be initialized with the initial accumulation level of n2.

The WTRU receives an indication (and/or the WTRU may implicitly determine) that the second TPC accumulator (e.g., the one or more SBFD TPC accumulators) is dependent on (e.g., linked to, mapped to, and/or associated with) a reference TPC accumulator which may be the first TPC accumulator (e.g., the one or more non-SBFD TPC accumulators).

In case of more than one non-SBFD TPC accumulators (e.g., the first TPC accumulator and a third TPC accumulator for use in the one or more non-SBFD symbols) associated with an SBFD TPC accumulator, the WTRU may receive an indication and/or a configuration indicating and/or identifying a set of non-SBFD TPC accumulators that are associated and/or linked to the SBFD TPC accumulator. In an example, the WTRU may receive the indication that the second TPC accumulator is dependent on (e.g. selectively dependent on) the first TPC accumulator and/or the third TPC accumulator.

In an example, the initial value of n2 may be the same as n1, when the second TPC accumulator is configured to be dependent on the first TPC accumulator.

In an example, one or more of the following PC parameters: P0, P_offset, alpha, and/or the PL RS of the second set of PC parameters may be configured to be same (and/or common) as those of the first set of PC parameters that corresponds to the reference TPC accumulator. The same and/or common parameters may be open loop parameters utilized for open loop power control.

The WTRU may receive a first TPC command (e.g., by a Downlink Control Information (DCI) etc.) indicating the CL-index #1 and a first value (C1 in dB, e.g., as a TPC command value of δ_{PUSCH}). The DCI (e.g., a DL grant, a UL grant, a DCI format 2_2 for transmission of the TPC commands for the PUCCH and/or the PUSCH, and/or the format 2_3, etc.) may comprise a Q-bit field (e.g., Q=2) for the TPC command, where a field value 0 may indicate −1 dB for an accumulated TPC and −4 dB for an absolute TPC, the field value 1 may indicate 0 dB for the accumulated TPC and −1 dB for the absolute TPC, the field value 2 may indicate 1 dB for the accumulated TPC and 1 dB for the absolute TPC, and the field value 3 may indicate 3 dB for the accumulated TPC and 4 dB for the absolute TPC. In an example, one or more step sizes of the first TPC command and the second TPC command may be independent of each other, for example, a power change in the second TPC (e.g. in the SBFD) may differ from a power change in the first TPC (e.g. in the non-SBFD) due to the CLI. In an example, a second step-size associated with the second TPC command may be different from a first step-size associated with a first TPC command. In an example, the second step-size may be lower or higher than the first step-size. The WTRU may receive the configuration information associated with the first step-size and/or the second step size. The WTRU may receive the configuration information including a difference between the first step-size and the second step-size.

In response to the first TPC command, the WTRU updates a value (e.g., a first accumulation level) of the first TPC accumulator to be n1+C1, and on condition that the WTRU determines the second TPC accumulator (e.g. as the dependent TPC accumulator) is dependent on the first TPC accumulator (e.g. as the reference TPC accumulator) associated with the CL-index #1, the WTRU updates a value (e.g., a second accumulation level) of the second TPC accumulator to be n2+C1. In an example, on a condition that the TPC accumulation is enabled (e.g., enabled by default, as long as an (optional) RRC parameter of tpc-Accumulation is not present and/or not configured), the WTRU may perform the TPC accumulation such that the current accumulation level (e.g., n1+C1, or n2+C1) remains (e.g., maintains) to be used as an updated initial value to be accumulated with a next TPC command value when received. In an example, on a condition that the TPC accumulation is disabled (e.g., when the (optional) RRC parameter of tpc-Accumulation is configured with an indication of “disabled”), the WTRU may apply the absolute (e.g., one-time and/or one shot) TPC level determination, e.g., as n1+C1 or n2+C1 which will no longer be accumulated with the next TPC command value when received.

The WTRU may receive a second TPC command (e.g., by the DCI) indicating the CL-index #2 and a second value (C2 in dB). In response to the second TPC command, the WTRU updates (e.g., only updates) the second TPC accumulator to add C2 to a current value (e.g., n2+C1+C2, if the TPC accumulation is enabled) of the second TPC accumulator, and maintains the value of the first TPC accumulator as n1+C1.

The WTRU may receive a first UL grant scheduling a first UL channel (e.g., physical uplink control channel (PUCCH), physical uplink shared channel (PUSCH), sounding reference signal (SRS), and/or physical random access channel (PRACH) etc.) to be transmitted on a first one or more symbols of a first symbol type (e.g., the one or more non-SBFD symbols etc.).

The WTRU may transmit the first UL channel using transmit power determined based on the first TPC accumulator (e.g., n1+C1). The WTRU may also determine the transmit power based on at least one of the first set of PC parameters and/or the second set of PC parameters (such as but not limited to P0, P_offset, alpha, and/or PL RS etc., for example).

The WTRU may receive a second UL grant scheduling a second UL channel (e.g., the PUSCH, the PUCCH, the SRS, and/or the PRACH etc.) to be transmitted on a second one or more symbols of a second symbol type (e.g., the one or more SBFD symbols etc.).

The WTRU may transmit the second UL channel using transmit power determined based on the second TPC accumulator (e.g., n2+C1+C2 as being dependent on the first TPC accumulator, if the TPC accumulation is enabled).

The WTRU may also determine the transmit power based on at least one of the second set of PC parameters, such as but not limited to P0, P_offset, alpha, and/or PL RS etc., for example, some of which may be the same as (e.g., linked to and/or shared with) those of the first set of PC parameters on a condition that the dependency of the second TPC accumulator is on the first TPC accumulator.

In an example, the technique of separate PC using separate TPC accumulators achieves separated UL PC across different symbol types to cope with the different interference types. The technique of separate PC using separate TPC accumulators reduces complexity of the WTRUs as the dependent TPC accumulator is not standalone but is dependent from the reference TPC accumulator. This also provides increased flexibility and reliability on managing PC by the network (NW), e.g., based on resetting the values of the dependent TPC accumulators by an indicated absolute ratio with respect to the current value of the reference TPC accumulator.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

Hereinafter, the term “sub-band” is used to refer to a frequency domain resource and may be characterized by at least one of the following: (1) a set of resource blocks (RBs), (2) a set of resource block sets (RB sets), e.g. when a carrier has intra-cell guard bands, (3) a set of interlaced resource blocks, (4) a bandwidth part and/or portion thereof, (5) a carrier and/or portion thereof. For example, a sub-band may be characterized by a starting RB and number of RBs for a set of contiguous RBs within a bandwidth part. A sub-band may also be defined by the value of a frequency domain resource allocation field and/or a bandwidth part index.

Hereinafter, the term “XDD” is used to refer to a sub-band-wise duplex (e.g., the UL and/or the DL being used per sub-band) and may be characterized by at least one of the following: (1) a cross division duplex (e.g., sub-band-wise FDD within a TDD band), (2) a sub-band-based full duplex (e.g., the full duplex as both the UL and the DL are used and/or mixed on a symbol and/or a slot, but the UL and/or the DL being used per sub-band on the symbol and/or the slot), (3) a frequency domain multiplexing (FDM) of the DL and/or the UL transmissions within a TDD spectrum, (4) an sub-band non-overlapping full duplex (SBFD) (e.g., non-overlapped sub-band full-duplex), (5) a full duplex other than a same-frequency (e.g., spectrum sharing and/or sub-band-wise-overlapped etc.) full duplex, and/or (6) an advanced duplex method, e.g., other than pure TDD and/or pure FDD.

Hereinafter, the term “dynamic and/or flexible TDD” is used to refer to a TDD system and/or cell which may dynamically (and/or flexibly) change, adjust, and/or switch a communication direction (e.g., a downlink, an uplink, and/or a side-link, etc.) on a time instance (e.g., the slot, the symbol, and/or a subframe, etc.). In an example, in a system employing dynamic and/or flexible TDD, a component carrier (CC) and/or a bandwidth part (BWP) may have one single type among ‘D’, ‘U’, and ‘F’ on the symbol and/or the slot, based on an indication by a group-common (GC) DCI (e.g., format 2_0) comprising a slot format indicator (SFI), and/or based on TDD-UL-DL-config-common/dedicated configurations. On a given time instance, slot, and/or symbol, a first gNB (e.g., a cell and/or a TRP etc.) employing the dynamic TDD and/or the flexible TDD may transmit a downlink signal to a first WTRU being communicated and/or associated with the first gNB based on a first SFI and/or TDD-UL-DL-config configured and/or indicated by the first gNB, and a second gNB (e.g., cell, TRP etc.) employing dynamic and/or flexible TDD may receive an uplink signal transmitted from a second WTRU being communicated and/or associated with the second gNB based on a second SFI and/or TDD-UL-DL-config configured and/or indicated by the second gNB. In an example, the first WTRU may determine that the reception of the downlink signal is being interfered by the uplink signal, where the interference caused by the uplink signal may refer to a WTRU-to-WTRU CLI.

A WTRU may transmit and/or receive a physical channel and/or a reference signal (RS) according to at least one spatial domain filter. The term “beam” may be used to refer to a spatial domain filter.

The WTRU may transmit the physical channel and/or the reference signal using the same spatial domain filter as the spatial domain filter used for receiving an RS (such as but not limited to channel state information RS (i.e. CSI RS) etc.) and/or a synchronization signal (SS) block. The WTRU transmission may be referred to as “target”, and the received RS and/or SS block may be referred to as “reference” and/or “source”. In such case, the WTRU may be said to transmit the target physical channel and/or signal according to a spatial relation with a reference to such RS and/or SS block.

The WTRU may transmit a first physical channel and/or signal according to the same spatial domain filter as the spatial domain filter used for transmitting a second physical channel and/or signal. The first and second transmissions may be referred to as “target” and “reference” (and/or “source”), respectively. In such case, the WTRU may be said to transmit the first (i.e. the “target”) physical channel and/or signal according to the spatial relation with the reference to the second (i.e. the “reference”) physical channel and/or signal.

The spatial relation may be implicit and/or may be configured by a radio resource control (RRC) and/or signaled by a medium access control (MAC) control element (CE) and/or the DCI etc., for example. In an example, the WTRU may implicitly transmit the PUSCH and a demodulation reference signal (DM RS) of the PUSCH according to the same spatial domain filter as a sounding reference signal (SRS) indicated by an SRS resource indicator (SRI) indicated in the DCI and/or configured by the RRC. In another example, the spatial relation may be configured by the RRC for the SRI and/or signaled by the MAC CE for the PUCCH. Such spatial relation may also be referred to as a “beam indication”.

The WTRU may receive a first (i.e. the “target”) downlink channel and/or signal according to the same spatial domain filter and/or spatial reception parameter as a second (i.e. the “reference”) downlink channel and/or signal. In an example, such association may exist between the physical channel such as but not limited to the PDCCH and/or the PDSCH and the respective DM RS. At least when the first and second signals are reference signals, such association may exist when the WTRU is configured with a quasi-colocation (QCL) assumption type D between corresponding antenna ports. Such association may be configured as a transmission configuration indicator (TCI) state. The WTRU may receive an indication, an information, and/or a configuration regarding an association between the CSI RS and/or the SS block and the DM RS by an index to a set of TCI states configured by the RRC and/or signaled by the MAC CE. In an example, the indication may also be referred to as a “beam indication”.

In an example, a unified TCI (e.g., a common TCI, a common beam, and/or a common RS, etc.) may refer to a beam and/or an RS to be used (e.g. simultaneously used) for multiple physical channels and/or signals. The term “TCI” may at least comprise a TCI state that includes at least one source RS to provide a reference (e.g., a WTRU assumption) for determining the QCL and/or the spatial filter.

In an example, the WTRU may receive (e.g., from the gNB) an indication of a first unified TCI to be used and/or applied for both, a physical downlink control channel (PDCCH) and a physical downlink shared channel (PDSCH) (and/or a downlink RS). In an example, one or more source reference signals in the first unified TCI may provide a common QCL information at least for a WTRU dedicated reception on the PDSCH and/or one or more CORESETs in a CC. In an example, the WTRU may receive (e.g., from the gNB) an indication of a second unified TCI to be used and/or applied for both, a physical uplink control channel (PUCCH) and/or a physical uplink shared channel (PUSCH) (and/or an uplink RS). In an example, one or more source reference signals in the second unified TCI may provide a reference for determining one or more common UL TX spatial filters at least for dynamic grant based PUSCH and/or configured grant based PUSCH and/or one or more dedicated PUCCH resources in the CC.

The WTRU may be configured with a first mode for the unified TCI (e.g., SeparateDLULTCI mode, a parameter of ‘unifiedTCI-StateType’ set to ‘separate’) where an indicated unified TCI (e.g., the first unified TCI or the second unified TCI) may be applicable for the downlink (e.g., based on the first unified TCI) and/or uplink (e.g., based on the second unified TCI).

In an example, the WTRU may receive (e.g., from the gNB) an indication of the second unified TCI to be used and/or applied commonly for the PDCCH, the PDSCH, the PUCCH, and/or the PUSCH (and/or a DL RS and/or a UL RS etc.) etc., for example.

The WTRU may be configured with a second mode for the unified TCI (e.g., JointTCI mode, a parameter of ‘unifiedTCI-StateType’ set to ‘joint’) where the indicated unified TCI (e.g., the third unified TCI) may be applicable for both, the downlink and the uplink (e.g., based on the third unified TCI), for example.

The WTRU may determine a TCI state applicable to a transmission and/or reception by first determining a unified TCI state instance applicable to the transmission and/or reception, then determining the TCI state corresponding to the unified TCI state instance. The transmission may include but is not limited to the PUCCH, the PUSCH, and/or the SRS etc., for example. The reception may include but is not limited to the PDCCH, the PDSCH, and/or the CSI RS etc., for example. The unified TCI state instance may also be referred to a TCI state group, a TCI state process, a unified TCI pool, a group of TCI states, a set of time domain instances, stamps, slots, and/or symbols, and/or a set of frequency domain instances, RBs, and/or sub-bands etc., for example. The unified TCI state instance may be equivalent to and/or identified by a coreset pool identity (e.g., CORESETPoolIndex, a TRP indicator, and/or the like).

Hereafter, the unified TCI may be interchangeably used with one or more of the unified TCI states, the unified TCI instance, the TCI, and/or the TCI-state, consistent with the present disclosure.

The WTRU may be configured with a plurality of TCI states, e.g., a plurality of unified TCI (UTCI) states, each applicable for one or more channels and/or one or more signals. The one or more channels and/or the one or more signals may be configured to the WTRU (and/or may be pre-determined and/or may be defined), e.g., in a form of a list, by a higher layer signaling (e.g., the RRC and/or the MAC CE etc.) which may include but is not limited to one or more of following parameters and/or a combination of parameters: (1) one or more CORESETs, (2) one or more PDCCH candidates, (3) one or more search spaces, (4) one or more PDSCHs (e.g., PDSCH occasions, configurations, and/or instances, etc.), (5) one or more RSs (e.g., CSI RSs, DMRSs, SSB indexes, PRSs, PTRSs, and/or SRSs), (6) one or more PUSCHs (e.g., PUSCH occasions, configurations, and/or instances, etc.), (7) one or more PUCCH resources (e.g., PUCCH resource sets and/or groups etc.), and/or (8) one or more PRACH occasions, resources, and/or RSs etc., for example.

In an example, the plurality of TCI states may be configured via the RRC signaling (and/or via the MAC CE signaling, indication and/or activation etc., for example). The WTRU may receive, e.g., via the MAC CE and/or via a separate signaling, an information content comprising a mapping between one or more codepoints of a DCI field (e.g., a TCI field, and/or a TCI selection field etc.) and at least one TCI state of the plurality of TCI states. The WTRU may receive the DCI including the DCI field. The WTRU may be indicated with one or more TCI states of the plurality of TCI states mapped to a codepoint of the one or more codepoints of the DCI field, where each of the one or more TCI states is applicable after a time duration determined based on a beam application time (BAT) parameter.

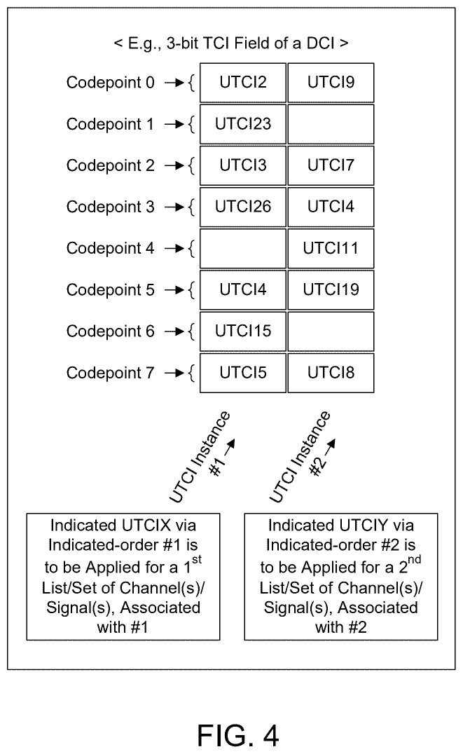

FIG. 4 is a diagram illustrating an example DCI field according to an embodiment. FIG. 4 shows an example of the DCI field (e.g., the TCI field) of the DCI for one or more unified TCI state indications. The WTRU may receive the mapping between the codepoint (of the DCI field) and the one or more TCI states, illustrated in FIG. 4, e.g., via the MAC-CE signaling. In an example, as shown in FIG. 4, Codepoint 2 is mapped to {UTCI3, UTCI7}, where the WTRU may apply at least one of {UTCI3, UTCI7} to the one or more channels and/or signals, e.g., based on a list of multiple channels and/or signals configurable by a higher layer signaling from the gNB. In an example, the list of the multiple channels and/or signals may be given per UTCI instance, where the UTCI instance may correspond to each column of a mapping table, illustrated in FIG. 4, between the codepoint and the one or more TCI states.

Hereafter, a transmission and reception point (TRP) may be interchangeably used with one or more of a transmission point (TP), a reception point (RP), a radio remote head (RRH), a distributed antenna (DA), a base station (BS), a sector (of a BS), and/or a cell (e.g., a geographical cell area served by a BS) etc., consistent with the present disclosure. Hereafter, a multi-TRP may be interchangeably used with one or more of a MTRP, a M-TRP, and multiple TRPs, consistent with the present disclosure.

The WTRU may report a subset of channel state information (CSI) components, where one or more CSI components may correspond to at least a CRI, a SSB resource indicator (SSBRI), an indication of a panel used for reception at the WTRU (such as but not limited to a panel identity or group identity), measurements such as but not limited to an L1 RSRP, an L1 SINR derived from the SSB and/or CSI RS (e.g. CRI RSRP, CRI SINR, SSB Index RSRP, and/or SSB Index SINR etc.), and other channel state information such as but not limited to a rank indicator (RI), a channel quality indicator (CQI), a precoding matrix indicator (PMI), and/or a layer index (LI), etc., for example.

The WTRU may receive a synchronization signal and/or a physical broadcast channel (SS/PBCH) block. The SS/PBCH block (SSB) may include a primary synchronization signal (PSS), a secondary synchronization signal (SSS), and/or a physical broadcast channel (PBCH) etc., for example. The WTRU may monitor, receive, and/or attempt to decode the SSB during initial access, initial synchronization, radio link monitoring (RLM), cell search, and/or cell switching etc., for example.

The WTRU may measure and/or report the CSI. The CSI for each connection mode may include and/or be configured with but not limited to one or more of following: (A) CSI report configuration, including but not limited to one or more of: (1) a CSI report quantity, e.g., a CQI, an RI, a PMI, a CRI, and/or a LI, etc., (2) a CSI report type, e.g., aperiodic, semi persistent and/or periodic etc., (3) a CSI report codebook configuration, e.g., Type I, Type II, Type II port selection, etc., and/or (4) a CSI report frequency, (B) a CSI RS resource set including but not limited to one or more of the following CSI resource settings: (1) NZP CSI RS Resource for channel measurement, (2) NZP CSI RS resource for interference measurement, and/or (3) CSI IM Resource for interference measurement, (C) NZP CSI RS resources including but not limited to one or more of: (1) NZP CSI RS Resource ID, (2) periodicity and offset, (3) QCL information and TCI state, and/or (4) resource mapping, e.g., number of ports, density, and/or CDM type, etc., for example.

The WTRU may indicate, determine, and/or be configured with one or more reference signals. The WTRU may monitor, receive, and/or measure one or more parameters based on the respective reference signals. Multiple parameters may be included in one or more reference signal measurements.

An SS reference signal received power (SS RSRP) may be measured based on one or more synchronization signals (e.g., the DMRS in the PBCH and/or the SSS etc.). The SS RSRP may be defined as a linear average over a power contribution of one or more resource elements (REs) that carry the respective synchronization signal. In measuring the RSRP, power scaling for the reference signals may be required. In case the SS RSRP is used for the L1 RSRP, the measurement may be accomplished based on the CSI reference signals in addition to the synchronization signals.

The CSI RSRP may be measured based on a linear average over a power contribution of the one or more REs that carry the respective CSI RS. The CSI RSRP measurement may be configured within one or more measurement resources for one or more configured CSI RS occasions.

An SS signal-to-noise and interference ratio (SS SINR) may be measured based on the one or more synchronization signals (e.g., the DMRS in the PBCH and/or the SSS). The SS SINR may be described as a linear average over a power contribution of the one or more REs that carry the respective synchronization signal divided by a linear average of a noise and interference power contribution. In case the SS SINR is used for the L1 SINR, the noise and interference power measurement may be accomplished based on one or more resources configured by higher layers.

A CSI SINR may be measured based on a linear average over a power contribution of the one or more REs that carry the respective CSI RS divided by a linear average of the noise and interference power contribution. In case the CSI SINR is used for the L1 SINR, the noise and interference power measurement may be accomplished based on resources configured by the one or more higher layers. Otherwise, the noise and interference power may be measured based on the resources that carry the respective CSI RS.

A received signal strength indicator (RSSI) may be measured based on an average of a total power contribution in one or more configured OFDM symbols and the bandwidth. The power contribution may be received from different resources (e.g., co-channel serving and/or non-serving cells, adjacent channel interference, and/or thermal noise, etc.)

A cross-layer interference received signal strength indicator (CLI RSSI) may be measured based on an average of a total power contribution in one or more configured OFDM symbols of the configured time and/or frequency resources. The power contribution may be received from different resources (e.g., cross-layer interference, co-channel serving and/or non-serving cells, adjacent channel interference, and/or thermal noise etc.)

An SRS RSRP may be measured based on a linear average over a power contribution of the one or more REs that carry the respective SRS.

In an example, a property of a grant and/or an assignment may include but is not limited to one or more of the following: (1) a frequency allocation, (2) an aspect of time allocation, such as but not limited to a duration, (3) a priority, (4) a modulation and coding scheme (MCS), (5) a transport block size, (6) a number of spatial layers, (7) a number of transport blocks, (8) a TCI state, CRI and/or SRI etc., (9) a number of repetitions, (10) whether the repetition scheme is Type A and/or Type B, (11) whether the grant is a configured grant Type 1, Type 2 and/or a dynamic grant, (12) whether the assignment is a dynamic assignment and/or a semi-persistent scheduling (configured) assignment, (13) a configured grant index and/or a semi-persistent assignment index, (14) a periodicity of a configured grant and/or assignment, (15) a channel access priority class (CAPC), (16) any parameter provided in the DCI, by the MAC or by the RRC for the scheduling, the grant and/or assignment etc., for example.

In an example, an indication by the DCI may include but is not limited to one or more of the following: (1) an explicit indication by the DCI field or by a RNTI used to mask a CRC of the PDCCH, (2) an implicit indication by a property such as a DCI format, a DCI size, a coreset and/or search space, an aggregation level, a first resource element of the received DCI (e.g., an index of a first control channel element (CCE) etc.), where the mapping between the property and the value may be signaled by the RRC and/or the MAC.

Hereafter, the signal may be interchangeably used with one or more of following: the SRS, the CSI RS, the DM RS, a phase tracking reference signal (PT RS), and/or the SSB etc., consistent with the present disclosure.

Hereafter, the channel may be interchangeably used with one or more of following: the PDCCH, the PDSCH, the PUCCH, the PUSCH, and/or the PRACH, etc., consistent with the present disclosure.

Hereafter, the downlink reception may be used interchangeably with an Rx occasion, the PDCCH, the PDSCH, and/or an SSB reception etc., consistent with the present disclosure.

Hereafter, the uplink transmission may be used interchangeably with a Tx occasion, the PUCCH, the PUSCH, the PRACH, and/or an SRS transmission etc., consistent with the present disclosure.

Hereafter, the RS may be interchangeably used with one or more of an RS resource, an RS resource set, an RS port and/or an RS port group etc., consistent with the present disclosure.

Hereafter, the RS may be interchangeably used with one or more of the SSB, the CSI RS, the SRS and/or the DM RS etc., consistent with the present disclosure.

Hereafter, the time instance may be interchangeably used with the slot, the symbol, and/or the subframe etc., consistent with the present disclosure.

Hereafter, the UTCI may be interchangeably used with the TCI, the UTCI state, and/or the TCI state etc., consistent with the present disclosure.

Hereafter, a UL-only and/or a DL-only Tx/Rx occasions may interchangeably be used with a legacy TDD UL and/or a legacy TDD DL, respectively, consistent with the present disclosure. In an example, the legacy TDD UL and/or the legacy TDD DL Tx and/or Rx occasions may be the cases where the SBFD is not configured and/or where the SBFD is disabled, for example.

Hereinafter, the terms a received signal power, a received signal energy, a received signal strength, an SSB EPRE, a CSI EPRE, an RSRP, an RSSI, an SINR, an RSRQ, an SS RSRP, an SS RSSI, an SS SINR, an SS RSRQ, a CSI RSRP, a CSI-RSSI, a CSI SINR, and/or a CSI RSRQ may be used interchangeably, consistent with the present disclosure.

Hereafter, a UL signal (e.g., at least one of the SRS, the DMRS, the PUSCH, the PUCCH, the PRACH, and/or the PTRS, etc.) may be used interchangeably with the UL signal and/or channel, or the UL channel and/or signal, consistent with the present disclosure.

Hereafter, a DL signal (e.g., at least one of the CSI RS, the SSB, the PDSCH, the PDCCH, the PBCH, and/or the PTRS, etc.) may be used interchangeably with a DL signal and/or a DL channel, consistent with the present disclosure.

In an example, the WTRU may operate in an SBFD mode. The WTRU may be configured with one or more types of slots within a bandwidth, wherein a first type of slot may be used or determined for a first direction (e.g., the downlink and/or the side-link (e.g., a WTRU-to-WTRU communication and/or a device-to-device communication) etc.); a second type of slot may be used or determined for a second direction (e.g., the uplink and/or the side-link etc.); a third type of slot may include a first group of frequency resources within the bandwidth for the first direction and a second group of frequency resources within the bandwidth for the second direction.

Herein, the bandwidth may be interchangeably used with the BWP, the carrier, the sub-band, and/or a system bandwidth etc., for example. The first type of slot (e.g., the slot for the first direction) may be referred to as the downlink slot (and/or the side-link slot), for example. The second type of slot (e.g., the slot for the second direction) may be referred to as the uplink slot (and/or side-link slot), for example. The third type of slot may be referred to as the sub-band (non-overlapping and/or overlapping) full duplex (SBFD) slot, e.g., comprising at least one or more of DL SBs, UL SBs, side-link SBs, guard bands (and/or RBs), and flexible SBs (e.g., the SBs that may be dynamically determined as one of the DL SBs, the UL SBs, and/or the side-link SBs) etc., for example. A group of frequency resources for the first direction may be referred to as the downlink (and/or the side-link) sub-band, the downlink (and/or the side-link) frequency resource, and/or downlink (and/or side-link) RBs. A group of frequency resources for the second direction may be referred to as the uplink (and/or the side-link) sub-band, the uplink (and/or the side-link) frequency resource, and/or uplink (and/or side-link) RBs. A group of frequency resource for a flexible direction (e.g., that may be configured for the first direction and/or the second direction, etc.) may be referred to as a flexible sub-band, a flexible frequency resource, and/or flexible RBs etc., for example. A group of frequency resource between the first direction and the second direction may be referred to as a guard band, a guard frequency resource, and/or one or more guard RBs.

In an example, a SBFD-enabled WTRU may receive configuration information and/or be configured with one or more SBFD UL, DL, side-link, flexible, and/or guard sub-bands in one or more DL, UL, and/or flexible TDD time instances (e.g., the symbols, the slots, and/or the frames etc.). The WTRU may be configured with one or more resource allocations for one or more SBFD sub-bands. In an example, the WTRU receives an SBFD configuration including a flag signal (e.g., enabled and/or disabled indication), where for example a first SBFD mode value (e.g., zero (0)) indicates a first mode of operation (e.g., SBFD configuration), and a second SBFD mode value (e.g., one (1)) may indicate a second mode of operation (e.g., non-SBFD operation). The modes of operation (e.g., SBFD and/or non-SBFD) may be indicated via the MIB, the SIB, the RRC, the MAC CE, and/or the DCI, etc.

The WTRU may receive one or more time resources (e.g., the one or more symbols, and/or the one or more slots etc.), for which the first SBFD mode of operation (e.g., SBFD enabled) is defined in, for example, one or more of the BWPs, the sub-bands, the CCs, and/or the cells etc., for example. The WTRU may receive one or more frequency resources (e.g., the sub-bands, the BWPs including one or more PRBs) within the BWP (e.g. the active and/or linked BWP), for which the first mode of operation (e.g., the SBFD) may be configured. In an example, one or more time instances (e.g., the slots and/or symbols) may be indicated based on the periodic, the semi-persistent, and/or an aperiodic type configuration etc., for example. In an example, the one or more time instances may be indicated via a bitmap configuration, where each bit corresponds to a time instance (e.g., the slot, the symbol, and/or the subframe etc.) and each bit indication indicates whether a corresponding time instance may be used for the first SBFD mode of operation and/or the second SBFD mode of operation.

In an example, the WTRU may be configured with the DL TDD configuration for the CC and/or the BWP for one or more Rx occasions (e.g., via TDD-UL-DL-config-common, one or more dedicated configurations, and/or an SFI etc.). As such, if the first mode of operation (e.g., the SBFD enabled) is configured, one or more of the configured frequency resources (e.g., the sub-bands, the PRBs, and/or the BWPs etc.) may be configured for the transmission in the UL channels and/or the Tx occasions.

In another example, the WTRU may be configured with the UL TDD configuration for the CC and/or the BWP for one or more Tx occasions (e.g., via TDD-UL-DL-config-common, one or more dedicated configurations, and/or an SFI etc.). As such, if the first mode of operation (e.g., the SBFD enabled) is configured, one or more of the configured frequency resources (e.g., the sub-bands, the PRBs, and/or the BWPs) may be configured as the DL channels and/or the Rx occasions.

In another example, the WTRU may be configured with the DL, UL, and/or a flexible TDD configuration for the CC and/or the BWP for the one or more Rx and/or Tx occasions (e.g., via TDD-UL-DL-config-common, the one or more dedicated configurations, and/or the SFI, etc.). As such, if the first mode of operation (e.g., the SBFD enabled) is configured, the one or more of the configured frequency resources (e.g., the sub-bands, the PRBs, and/or the BWPs) may be configured for the first mode of operation (e.g., the UL transmission and/or the DL reception based on the configurations).

The duplexing mode for the first mode of operation (e.g., the SBFD configuration (the UL and/or the DL) etc.) may be indicated via a flag indication, where for example the first SBFD mode value (e.g., zero (0)) may indicate the first direction (e.g., UL duplexing mode), and the second SBFD mode value (e.g., one (1)) may indicate the second direction (e.g., a DL duplexing mode).

The duplexing mode configuration and/or the flag for the first mode of operation (e.g., the SBFD enabled) may be configured as a part of one or more modes of operation configuration, for example via the MIB, the SIB, the RRC, the DCI, and/or the MAC CE, etc.

The duplexing mode configuration and/or flag for the first mode of operation (e.g., the SBFD enabled) may be configured as part of a resource allocation configuration for a Tx and/or Rx occasion.

In an example, the WTRU may be configured with one or more types of slots. The WTRU may be configured with a first slot with a first type, where the first type may be for example, an SBFD slot. The WTRU may be configured with a second slot with a second type, where the second type may be for example, a non-SBFD slot. As for the first slot with the first type (e.g. the SBFD slot), the WTRU may be configured with one or more DL, UL, flexible, and/or guard, etc. sub-bands in the frequency domain, throughout the BWP, for the duration of the first slot. However, in the second slot with the second type (e.g. the non-SBFD slot), the WTRU may be configured with only one direction type, for example the DL, the UL, and/or the flexible, etc., in the frequency domain, throughout the BWP, for the duration of the second slot.

In an example, if the WTRU is configured with a second slot with the UL direction, this implies the legacy TDD UL slot, the UL-only slot, and/or the non-SBFD UL slot etc., for example. In another example, if the WTRU is configured with a third slot with the second type (e.g. the non-SBFD slot) with the DL direction, this implies legacy the TDD DL slot, the DL-only slot, and/or the non-SBFD DL slot. In another example, if the WTRU is configured with a fourth slot with the second type (e.g. the non-SBFD slot) with flexible direction, this implies the legacy TDD flexible slot and/or the non-SBFD flexible slot etc.

In an example, the WTRU may receive configurations of (e.g., may be configured with) the SBFD sub-band time locations that may be configured within a period. In an example, the period may be the same as the TDD-UL-DL pattern period configured by DL-UL-TransmissionPeriodicity, e.g., in the TDD-UL-DL-ConfigCommon. In an example, the period may be an integer multiple of the TDD-UL-DL pattern period configured by DL-UL-TransmissionPeriodicity, e.g., in the TDD-UL-DL-ConfigCommon.

When a (e.g., one and/or only one) TDD-UL-DL pattern is configured, the one or more SBFD symbols may be configured in consecutive manner within the TDD-UL-DL pattern period. When two TDD-UL-DL patterns are configured and if the one or more SBFD symbols are configured for only one of the patterns, the one or more SBFD symbols may be configured in consecutive manner within the TDD-UL-DL pattern period. When two TDD-UL-DL patterns are configured and if the one or more SBFD symbols are configured for both patterns, the one or more SBFD symbols may be configured in consecutive manner within each TDD-UL-DL pattern period.

The WTRU may determine (or be indicated and/or configured with) that one or more ‘UL usable PRBs’ are a part of one or more UL sub-band frequency resources within an UL BWP (e.g., an active UL BWP and/or a currently active UL BWP etc.), and one or more ‘DL usable PRBs’ are a part of a DL sub-band frequency resources within a DL BWP (e.g., an active DL BWP and/or a currently active DL BWP etc.). The UL usable PRBs may be determined as an intersection between a configured or indicated UL sub-band and an active UL BWP in the one or more SBFD symbols (and/or slots). The DL usable PRBs may be determined as an intersection between one or more configured and/or indicated DL sub-bands and the active DL BWP in the one or more SBFD symbols (and/or slots). In an example, the one or more UL and/or DL usable PRBs may be explicitly configured within active UL and/or DL BWP, e.g., in the one or more SBFD symbols and/or slots.

In an example, the WTRU may receive information on frequency resource allocation (e.g., Type 0 as RBG-level bitmap-based resource assignment) for the PDSCH and/or the PUSCH (as being scheduled) in one or more slots. When an assigned RBG overlaps with a sub-band boundary, the WTRU may determine that only the PRBs within the one or more DL usable PRBs are to be valid for the PDSCH reception and only the PRBs within the one or more UL usable PRBs are to be valid for the PUSCH transmission, e.g., where this may imply that a “partial RBG” is allowed and/or valid for resource allocation.

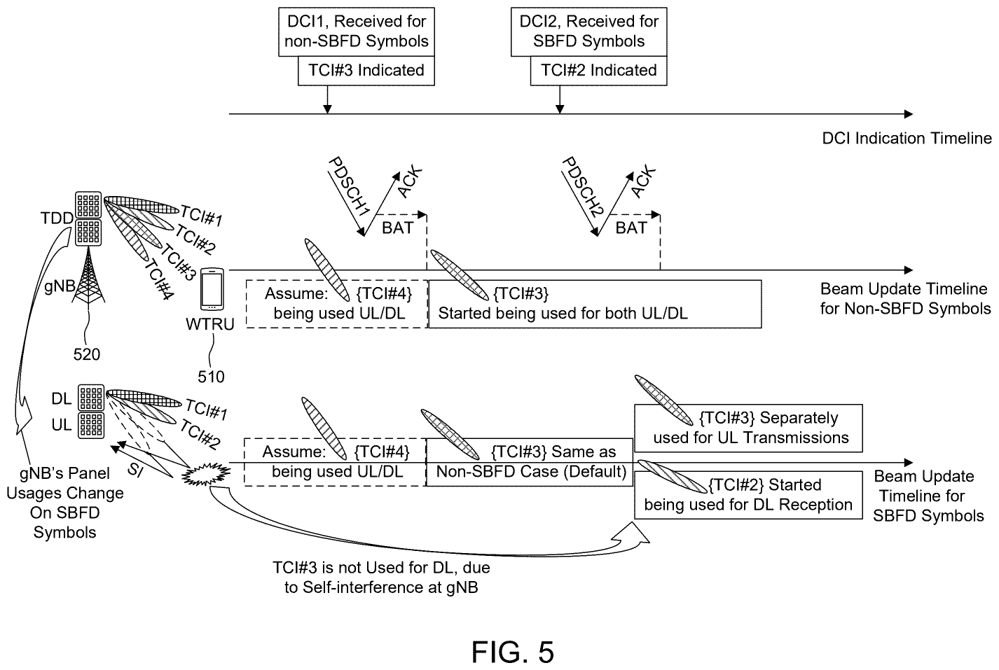

FIG. 5 is a diagram illustrating an example TCI and/or beam control across one or more FD and/or one or more non-FD symbols according to an embodiment. In Rel-19 NR-Duplex, an issue for separate QCL and/or TCI state configurations for SBFD symbol type and/or non-SBFD symbol types was identified due to different interference natures on different symbol types including non-negligible self-interference when using a DL beam on the one or more SBFD symbols. FIG. 5 is an example of separated beam and/or TCI control across different SBFD symbol types in a single TRP scenario and under unified TCI (i.e. the UTCI) framework. A WTRU 510 may receive configuration information from a gNB 520. The configuration information may be indicative of the plurality of TCI states. The WTRU 510 may receive a TCI activation command (e.g., via the MAC-CE) indicating (e.g., activating and/or updating, etc.) a set of activated TCI states (e.g., first through fourth TCI states (TCI #1, TCI #2, TCI #3, TCI #4) as shown in FIG. 5, for example) among the plurality of TCI states. In an example, the WTRU 510 may maintain (e.g., track and/or keep tracking) one or more QCL properties based on RSs within the set of activated TCI states, where the one or more QCL properties may include but are not limited to one or more of: an average delay, a doppler shift, a delay spread, a doppler spread, a spatial Rx, and/or an average power etc., e.g., upon receiving the TCI activation command. In an example, the WTRU 510 may not maintain and/or track the one or more QCL properties for the RS of the TCI state (among the plurality of TCI states) that is not activated by the TCI activation command. The set of activated TCI states may be ready for being used for the transmission and/or the reception when scheduled.

The WTRU 510 may receive a first DCI (i.e. DCI1 as shown in FIG. 5) scheduling a first PDSCH (i.e. PDSCH1 as shown in FIG. 5) or without scheduling the PDSCH, and indicating a first TCI state (e.g., TCI #3 as shown in FIG. 5) among the set of activated TCI states. The WTRU 510 may receive (e.g., decode and/or demodulate) the first PDSCH using TCI #X (e.g., X=4) that is a previously indicated TCI state which may not be the same as the indicated TCI #3. In response to receiving the first PDSCH (using TCI #4), the WTRU 510 may transmit an acknowledgement (i.e. ACK) to the gNB 520 for indicating a successful reception of the first PDSCH and/or a successful reception of the indicated first TCI state (i.e. TCI #3). The WTRU 510 may (be configured to) start to apply the indicated first TCI state (i.e. TCI #3) T_BAT after transmitting the ACK, where a value of the BAT, e.g., the T_BAT, may be configured by the gNB 520. Until further receiving a second indicated TCI state (e.g., by DCI2 as shown in FIG. 5), the WTRU 510 may maintain (e.g., in terms of the QCL properties) the indicated first TCI state (TCI #3) for use of communications (for the UL transmissions and/or the DL receptions) with the gNB 520.

The WTRU 510 may determine that the reception of the DCI1 and/or the first TCI state (i.e. TCI #3) is associated with the one or more non-SBFD symbols, e.g., in terms of TCI and/or beam update. The determination may be based on an explicit indication from the gNB 520 and/or may be based on an implicit rule, e.g., on condition of the one or more symbols where the DCI1 is received, which CORESET (and/or search space) the DCI1 is received, which RNTI the detected DCI1 is scrambled with, etc. Based on determining that the reception of the DCI1 and/or the first TCI state (i.e. TCI #3) is associated with the one or more non-SBFD symbols, the WTRU 510 may update the indicated first TCI state (i.e. TCI #3) for the UL transmissions and/or the DL receptions, e.g., at least for the one or more non-SBFD symbols, and/or for both, the one or more non-SBFD symbols and the one or more SBFD symbols until a SBFD-specific TCI control command is received. In an example (e.g., by default), until (e.g., unless) the SBFD-specific TCI control command is received, the WTRU 510 may use the first TCI state (i.e. TCI #3) also in association with the one or more SBFD symbols, e.g., for the UL transmissions and/or the DL receptions. In an example, the WTRU 510 may transmit a first UL channel and/or signal (e.g., the PUSCH, the PUCCH, and/or the SRS) using the first TCI state (i.e. TCI #3), and/or receive a first DL channel and/or signal (e.g., the PDSCH, the PDCCH, and/or the CSI RS) using the first TCI state (i.e. TCI #3).

The WTRU 510 may receive a second DCI (i.e. DCI2) scheduling a second PDSCH (i.e. PDSCH2) (and/or without scheduling the PDSCH) and indicating a second TCI state (i.e. TCI #2) among the set of activated TCI-states. The WTRU 510 may receive (e.g., decode and/or demodulate) the second PDSCH using a previously indicated TCI state (which is TCI #3 indicated by the DCI1 as shown in FIG. 5). In response to receiving the second PDSCH (using TCI #3), the WTRU 510 may transmit the ACK to the gNB 520 indicating a successful reception of the second PDSCH and/or a successful reception of the indicated first TCI state (i.e. TCI #2). The WTRU 510 may start to apply and/or may be configured to apply the indicated second TCI state (i.e. TCI #2) for at least one communication direction (e.g., DL), T_BAT2 after transmitting the ACK, where a BAT of T_BAT2 may be configured by the gNB 520 and may be same as or independent from the T_BAT.

The WTRU 510 may determine that the reception of the DCI2 and/or the second TCI state (i.e. TCI #2) is associated with the one or more SBFD symbols, e.g., in terms of TCI and/or beam update, where the reception of the DCI2 may correspond to the SBFD-specific TCI control command. The determination may be based on an explicit indication from the gNB 520 and/or based on an implicit rule, e.g., on condition of the one or more symbols where the DCI2 is received, which CORESET (and/or search space) the DCI2 is received on, and/or which RNTI the detected DCI2 is scrambled with, etc. Based on determining that the reception of the DCI2 and/or the second TCI state (i.e. TCI #2) is associated with SBFD symbols, the WTRU 510 may update the indicated second TCI state (i.e. TCI #2) for one communication direction (e.g., the UL transmission and/or the DL reception), where the one communication direction the WTRU 510 applies for may be configured and/or pre-configured and/or indicated (e.g. separately indicated) by the gNB 520. In an example, based on determining that the reception of the DCI2 and/or the second TCI state (i.e. TCI #2) is associated with the one or more SBFD symbols, the WTRU 510 may update the indicated second TCI state (i.e. TCI #2) for the DL reception (e.g., on condition that the one communication direction is configured and/or indicated as the DL direction), e.g., while the WTRU 510 may continue to use the first TCI state (i.e. TCI #3) in association with the one or more SBFD symbols for the UL transmissions. In an example, the WTRU 510 may continue to use the first TCI state (i.e. TCI #3) in association with the one or more non-SBFD symbols, e.g., for the UL transmissions and/or the DL receptions.

In an example, based on determining that the reception of the DCI2 and/or the second TCI state (i.e. TCI #2) is associated with the one or more SBFD symbols, the WTRU 510 may update the indicated second TCI state (i.e. TCI #2) for (e.g., both) the UL transmissions and/or the DL receptions which the WTRU 510 performs on the one or more SBFD symbols, while the WTRU 510 may continue to use the first TCI state (i.e. TCI #3) in association with the one or more non-SBFD symbols, e.g., for the UL transmissions and/or the DL receptions.

Based on receiving the SBFD-specific TCI control command (e.g., the DCI2), the WTRU 510 may transmit a second UL channel and/or signal using the first TCI state (i.e. TCI #3) on the one or more SBFD symbols and/or the one or more non-SBFD symbols. The WTRU 510 may receive a second DL channel and/or signal using the second TCI state (i.e. TCI #2) on the one or more SBFD symbols, while the WTRU 510 may receive a third DL channel and/or signal by using the first TCI state (i.e. TCI #3) on the one or more non-SBFD symbols. This may provide benefits in terms of improving reliability in one communication direction performance (e.g., the UL performance) while maintaining an optimized performance for another (e.g., the other) communication direction, e.g., when the gNB transmits the DL signal from a first gNB panel and simultaneously receives the UL signal at a second gNB panel, and one or more of DL beams (e.g. TCIs such as but not limited to TCI #3, TCI #4 etc.) cause a self-interference (SI) on the UL reception, e.g., due to signal reflection, diffraction, by a clutter, obstacle, and/or by a non-ideal spatial-separation between the first and second gNB panels, etc.

In an example, the WTRU may receive configurations (e.g., from the gNB, the node, and/or any device etc.) for a FD operation conducted by at least one device in a network. In an example, the FD operation may be conducted by the gNB (e.g., the BS, the node, the TRP and/or the cell etc.). The WTRU may operate in a half-duplex (HD) mode for communicating with the gNB, where the HD mode may imply at a given time the WTRU performs the UL transmission and/or the DL reception (in some examples, not both simultaneously at the given time). The WTRU may also operate in the FD mode for communicating with the gNB, e.g., if one or more corresponding WTRU capability signals are reported to the gNB and/or the WTRU receives a confirmation signal (e.g., enabling the FD and/or configuring the FD mode) in response to transmitting the one or more WTRU capability signals.

The FD operation may imply at a given time a transmitter (e.g., the gNB and/or the WTRU) may simultaneously transmit a first signal and receive a second signal. The FD operation may comprise a sub-band overlapping FD (e.g., in-band FD (IBFD)) operation where a first frequency-domain resource (e.g., the one or more RBGs, RBs, and/or REs etc.) allocated for the first signal may have a full (and/or at least a partial) overlap with a second frequency-domain resource allocated for the second signal. The FD operation may comprise a sub-band non-overlapping FD (i.e. the SBFD) operation where a first frequency-domain resource allocated for the first signal (e.g., assigned within a configured SBFD sub-band, e.g., the DL sub-band and/or the one or more usable DL PRBs etc.) does not have an overlap with a second frequency-domain resource allocated for the second signal (e.g., assigned within a configured SBFD sub-band, e.g., the UL sub-band and/or the one or more usable UL PRBs etc.).

Hereafter, the FD operation may comprise the SBFD operation, however the solutions and examples in the present disclosure may equally (and/or equivalently and/or extendedly, etc.) be employed (e.g., applicable) for cases with other FD operation types (e.g., the IBFD, etc.).

The WTRU may receive one or more SBFD-related configurations, e.g., for the frequency-domain location information of the one or more sub-bands (e.g., the DL sub-band, the UL sub-band, the flexible DL and/or UL sub-band, and/or the guard band etc.), and/or for the time-domain location information of the one or more sub-bands. The time-domain location information may indicate a set of non-SBFD symbols and/or a set of SBFD symbols (e.g., as illustrated in FIG. 2). The one or more symbols within the set of non-SBFD symbols may be a type of ‘DL symbol’, ‘UL symbol’ and/or ‘flexible symbol’. The WTRU may receive the DL signal on the one or more symbols based on a type of a DL symbol in the set of non-SBFD symbols. The WTRU may transmit the UL signal on the one or more symbols based on a type of a UL symbol in the set of non-SBFD symbols. The WTRU may receive the DL signal and/or transmit the UL signal on the one or more symbols based on a type of a flexible symbol in the set of non-SBFD symbols, e.g., depending on one or more conditions with other signals co-existing in the one or more symbols.

The WTRU may receive one or more configurations and/or a configuration information related to the TCI, e.g., comprising the plurality of TCI states (e.g., an RRC-configured pool of TCI states (e.g., as a unified TCI framework), TCI state IE, TCI UL state IE, and/or a spatialRelationInfo IE, etc.). The one or more TCI states of the plurality of TCI states may be associated (and/or comprised) with at least one of QCL-info #1, QCL-info #2, additionalPCI, pathloss RS (PLRS)-ID, UL-PC, timing advance group (TAG)-ID, where QCL-info #1 (or QCL-info #2) may comprise a cell-ID (e.g., serving-cell index), a BWP-ID, a RS (e.g., the CSI RS and/or the SSB index etc.), and/or a QCL type which may be one of typeA, typeB, typeC, and/or typed etc., for example. In an example, the PLRS ID may be for a pathloss estimation for determining a UL transmission power when the UL transmission is based on the TCI state that is associated with the PLRS ID. In an example, the UL PC (e.g., the UL PC parameter set, which may comprise but is not limited to one or more of P0, alpha, the CL index and/or the power offset, etc.) may be used for determining an uplink power for the UL transmission associated with the TCI state. In an example, the additionalPCI may be a physical cell ID (PCID) of a neighboring (and/or surrounding) cell that the RS (associated with the TCI state), e.g., the SSB index (and/or the CSI RS) may be transmitted from, e.g., as an inter-cell beam (and/or the RS) reference. In an example, the WTRU may apply a timing advance value (e.g., based on one or more received timing advance command (TACs) etc.) in association with the TAG ID (e.g., of multiple TAG IDs being configured) to a scheduled UL transmission.

In an example, the type A may represent one or more of: the doppler shift, the doppler spread, the average delay, and/or the delay spread. In an example, the type B may represent one or more of: the doppler shift and/or the Doppler spread. In an example, the type C may represent one or more of: the doppler shift and/or average delay. In an example, the type D may represent a spatial Rx parameter etc.

When the WTRU receives the indication and/or the configuration of the TCI state (e.g., applicable for the physical channel and/or signal) at least comprising the QCL type (e.g., by the type A, the type B, the type C, and/or the type D etc.) and the RS (e.g., the RS associated with the QCL type), the WTRU may determine (e.g., derive) at least one parameter for transmission and/or reception, representing wireless channel characteristics (e.g., at least one of the doppler shift, the doppler spread, the average delay, the delay spread, and/or the spatial Rx parameter etc.) based on the indicated QCL type, and apply the at least one parameter for transmission and/or reception of the physical channel and/or signal.

In addition to the examples based on FIG. 5, the UL Tx power control may be separately controlled across different symbol types, e.g., due to the different interference natures across the different symbol types. Depending on an actual UL transmission case, the separated UL Tx power level may or may not be needed in addition to an existing PC operation where each TCI state may be associated with one or more PC parameter sets (e.g., P0, alpha, PLRS, and/or CLPC-index). In an example, a higher UL Tx power may be required in some cases in the one or more SBFD symbols for the gNB to efficiently deal with the SI and/or the CLI, e.g., from the DL transmission of the other gNBs.

In an example, the WTRU may receive one or more configurations and/or one or more configuration information indicative of one or more sets of PC parameters (i.e. one or more PC parameter sets). In an example, the WTRU may receive a first set of PC parameters (e.g., for use in the one or more non-SBFD symbols) which may include but are not limited to one or more of: P0, P_offset, alpha, PL RS, and/or the first CL index (i.e. the CL-index #1) etc., for example. The WTRU may determine the UL Tx power level (P) based at least on the first set of PC parameters, e.g., on a given time i,

P(i)=P0+P_offset (i)+alpha*PL(i) (estimated by the PL RS)+a value of the first TPC accumulator (with the initial value of n1) associated with the CL-index #1.

In an example, a second set of PC parameters (e.g., for use in the one or more SBFD symbols) which may include but are not limited to one or more of: P0, P_offset, alpha, the PL RS, and/or the second CL index (i.e. the CL-index #2) etc., where the CL-index #2 is associated with the second TPC accumulator (with an initial value of n2).

In an example, the WTRU receives the indication (and/or the WTRU implicitly determines) that the second TPC accumulator (e.g., the SBFD TPC accumulator) is dependent on the reference TPC accumulator which may be the first TPC accumulator (e.g., the non-SBFD TPC accumulator).

If there is more than one non-SBFD TPC accumulator (e.g., the first TPC accumulator and the third TPC accumulator for use in the one or more non-SBFD symbols), the WTRU receives the indication and/or the configuration indicating which of the non-SBFD TPC accumulators are linked to the SBFD TPC accumulator, e.g., the second TPC accumulator is dependent on selectively the first and/or the third TPC accumulators.

In an example, the initial value of n2 may be the same as n1, when the second TPC accumulator is configured to be dependent on the first TPC accumulator. In an example, the first and second TPC accumulators may be initialized by the common accumulation level when the second TPC accumulator is configured to be dependent on the first TPC accumulator.

In an example, at least one of the PC parameters: P0, P_offset, alpha, and/or the PL RS etc. of the second set of PC parameters may be configured to be same (and/or common) as those of the first set of PC parameters that correspond to the reference TPC accumulator. In an example, the common and/or same parameters may be one or more open loop PC parameters.

The WTRU receives the first TPC command (e.g., by the DCI) indicating the CL-index #1 and the first value (C1 in dB). In response to the first TPC command, the WTRU updates the value (e.g., the accumulation level) of the first TPC accumulator to be n1+C1. In response to the first TPC command, on a condition that the WTRU determines the second TPC accumulator is dependent on the first TPC accumulator (e.g. as the reference TPC accumulator) associated with the CL-index #1, the WTRU updates the value (e.g., the accumulation level) of the second TPC accumulator to be n2+C1.

The WTRU receives the second TPC command (e.g., by the DCI) indicating the CL-index #2 and the second value (C2 in dB). In response to the second TPC command, the WTRU updates (e.g., only updates) the second TPC accumulator to be the current value in addition to C2 (e.g., n2+C1+C2, if the TPC accumulation is enabled), and maintains the value of the first TPC accumulator as n1+C1.

The WTRU receives the first UL grant scheduling the first UL channel (e.g., the PUSCH, the PUCCH, the SRS, and/or the PRACH etc.) to be transmitted on the first one or more symbols of the first symbol type (e.g., the one or more non-SBFD symbols).

The WTRU transmits the first UL channel using the transmit power determined based on the first TPC accumulator (e.g., n1+C1).

The WTRU may also determine the transmit power based on at least one of the first set of PC parameters and/or the second set of PC parameters, such as but not limited to P0, P_offset, alpha, and/or the PL RS etc.

The WTRU receives the second UL grant scheduling the second UL channel such as but not limited to the PUSCH, the PUCCH, the SRS, and/or the PRACH etc. to be transmitted on the second one or more symbols of a second symbol type (e.g., the one or more SBFD symbols).

The WTRU transmits the second UL channel using transmit power determined based on the second TPC accumulator (e.g., n2+C1+C2 as being dependent on the first TPC accumulator, if the TPC accumulation is enabled).

The WTRU may also determine the transmit power based on at least one of the second set of PC parameters, such as but not limited to P0, P_offset, alpha, and/or the PL RS etc., some of which may be the same as (e.g., linked to and/or shared with) those of the first set of PC parameters on condition that the dependency of the second TPC accumulator is on the first TPC accumulator.

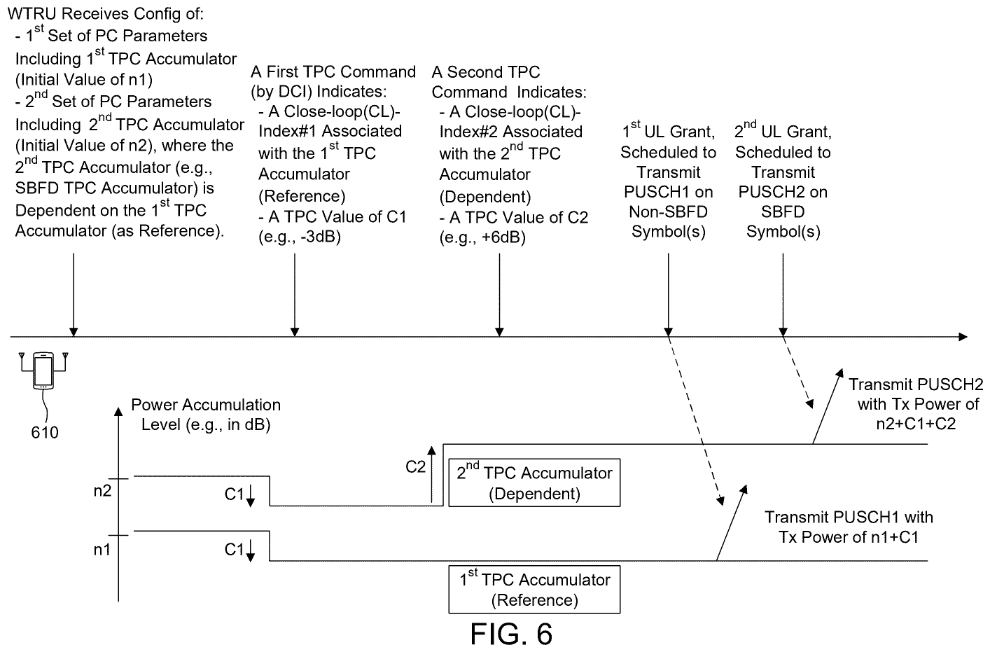

FIG. 6 is a diagram illustrating example power accumulation levels of reference and dependent TPC accumulators according to an embodiment. The WTRU 610 may implement one or more UL PC techniques including one or more TPC accumulators.

As illustrated in FIG. 6, the WTRU 610 may receive the one or more configurations and/or the one or more configuration information and/or one or more indications of the first set of PC parameters (e.g., for use in the one or more non-SBFD symbols, associated with the plurality of TCI states, and/or based on corresponding parameters of the PLRS ID and/or the UL PC associated with the one or more TCI states etc.), which may include but are not limited to one or more of: PC-MAX, P0, P_offset, alpha, the PL RS, the first CL index (i.e. the CL-index #1). The WTRU 610 may determine the UL Tx power level (P) based on the first set of PC parameters, e.g., on a given time occasion i,

P(i)=P0+P_offset (i)+alpha*PL(i) (estimated by the PL RS)+the value of the first TPC accumulator (with the initial value of n1) associated with the CL-index #1.

In an example, P(i) may be upper-bounded by a maximum transmit power level and/or a maximum transmit power value, i.e. PC-MAX. In an example, the WTRU 610 may determine P(i)=PC-MAX if P(i) exceeds PC-MAX. The value of n1 may be explicitly configured and/or indicated. In a solution, the WTRU 610 may determine the initial value of n1 equal to (e.g., equivalent to, based on, and/or same as etc.) a RACH transmission power (e.g., the current and/or the most recent PRACH Tx power, and/or the PRACH power ramp-up based on one or more PRACH power ramping procedure and/or steps, and/or plus an additional power offset that is configured and/or indicated etc.).

The WTRU 610 may receive the one or more configurations indicative of a second set of PC parameters (e.g., for use in the one or more SBFD symbols, associated with the one or more TCI states, based on the one or more corresponding parameters of the PLRS ID and/or the UL PC associated with the one or more TCI states etc.) which may include but are not limited to one or more of PC-MAX, P0, P_offset, alpha, the PL RS, and/or the second CL index (i.e. the CL-index #2) etc., for example. The WTRU 610 may determine the UL Tx power level based on the second set of PC parameters, e.g., on a given time occasion i, as P0+P_offset (i)+alpha*PL(i) (estimated by the PL RS)+the value of the second TPC accumulator (with the initial value of n2). The value of n2 may be explicitly configured and/or indicated. In an example, the WTRU 610 may determine the initial value of n2 equal to (e.g., equivalent to, based on, same as) the current (and/or the most recent) P(i) based on the first set of PC parameters (e.g., for use in the one or more non-SBFD symbols, and/or plus an additional power offset) and/or the RACH transmission power (e.g., the current and/or the most recent PRACH Tx power, and/or the PRACH power ramp-up based on the PRACH power ramping procedure and/or steps, and/or plus the additional power offset that is configured and/or indicated etc.).

In an example, the WTRU 610 may receive the indication (and/or the WTRU 610 may implicitly determine) that the second TPC accumulator (e.g., a SBFD TPC accumulator) is dependent on the reference TPC accumulator which may be the first TPC accumulator (e.g., a non-SBFD TPC accumulator). If there is more than one non-SBFD TPC accumulator (e.g., the first TPC accumulator and/or the third TPC accumulator for use in the one or more non-SBFD symbols), the WTRU 610 may receive the indication and/or the configuration indicating which ones the SBFD TPC accumulator is linked to, e.g., the second TPC accumulator is selectively dependent on the first and/or third TPC accumulators. In an example, the initial value of n2 may be the same as (and/or equivalent to, based on, and/or equal to etc.) n1 (and/or the additional power offset that is configured and/or indicated), when the second TPC accumulator is configured to be dependent on the first TPC accumulator. In an example, one or more of: P0, P_offset, alpha, the PL RS of the second set of PC parameters may be configured to be same (and/or common) as those of the first set of PC parameters that correspond to the reference TPC accumulator.

In an example, the WTRU 610 may receive the one or more values for indicating the maximum UL power, to be applied for determining the UL transmission power for one or more UL transmissions in different symbol types. In an example, the WTRU 610 may receive one or more PC-MAX values to be applied for determining the UL transmission power in one or more configured and/or indicated symbol types. In an example, the WTRU 610 may apply the configured and/or indicated PC-MAX values for determining the UL transmission power for the one or more UL transmissions, for example the PUSCH, the PUCCH, the SRS, and/or the PRACH, etc.

In an example, the WTRU 610 may be configured and/or indicated with the first PC-MAX value to be applied for determining the UL transmission power in the one or more symbols with the first type and the second PC-MAX value to be applied for determining the UL transmission power in symbols with the second type. For example, the symbols with the first type may include the one or more non-SBFD symbols and/or the one or more symbols with the second type may include the one or more SBFD symbols.

In an example, the WTRU 610 may use the configured and/or indicated one or more PC-MAX values to determine the maximum value for determining the UL transmission power. That is the WTRU 610 may limit the UL transmission power to the configured and/or indicated PC-MAX values. In an example, the WTRU 610 may limit the UL transmission power to the configured and/or indicated first PC-MAX value for UL transmissions in the one or more symbols with the first type (e.g., the one or more non-SBFD symbols). In another example, the WTRU 610 may limit the UL transmission power to the configured and/or indicated second PC-MAX value for the UL transmissions in the one or more symbols with the second type (e.g., the one or more SBFD symbols).

In an example, the WTRU 610 may receive the one or more PC-MAX values based on explicit and/or implicit indications. For example, the WTRU 610 may receive the one or more PC-MAX values via explicit indication, for example through the SIB, the RRC, the MAC CE, the DCI, etc. signaling. In another example, the WTRU 610 may receive at least one of the PC-MAX values via the explicit indication (e.g., an absolute value) in addition to one or more delta and/or offset values for determining the other PC-MAX values. For example, the WTRU 610 may receive the first PC-MAX value to be applied in symbols with the first type (e.g., the one or more non-SBFD symbols) in addition to the offset value, where the WTRU 610 may determine the second PC-MAX value to be applied in symbols with second type (e.g., the one or more SBFD symbols) accordingly. For example, the WTRU 610 may determine the second PC-MAX value by adding the indicated and/or configured first PC-MAX value and the indicated and/or configured offset value.

As illustrated in FIG. 6, the WTRU may receive the first TPC command (e.g., by the DCI, the DCI for the TPC command, e.g., by the DCI format 2_2 and/or the DCI format 2_3 at least indicating the CL index and/or the power value (e.g. in dB) etc.) indicating the first CL index (i.e. the CL-index #1) and the first value (C1 in dB). In response to the first TPC command, the WTRU may update the value (e.g., the accumulation level) of the first TPC accumulator to be n1+C1, and on condition that the WTRU determines the second TPC accumulator is dependent on the first TPC accumulator (as the reference TPC accumulator) associated with the first CL index (i.e. the CL-index #1), the value (e.g., the accumulation level) of the second TPC accumulator to be n2+C1. This may provide benefits in terms of TPC signaling overhead reduction and signaling efficiency, in that the dependent TPC accumulator (e.g., the second TPC accumulator) may also update the power accumulation level based on receiving the TPC command associated with the reference TPC accumulator (e.g., the first TPC accumulator). This may imply that the operation (e.g., the UL transmission) on the non-SBFD symbol type is the default symbol type, such that the TPC command for the first TPC accumulator is applied for both, the reference and the corresponding dependent TPC accumulators together.

The WTRU may receive the second TPC command (e.g., by the DCI) indicating the second CL index (i.e. the CL-index #2) and the second value (C2 in dB). In response to the second TPC command, the WTRU may update (e.g., only update) the second TPC accumulator to be the current value (e.g., n2+C1) plus C2 (i.e. n2+C1+C2), and/or maintain the value of the first TPC accumulator as n1+C1. This may provide benefits in terms of achieving separated UL PC across different symbol types to cope with the different interference natures and/or WTRU complexity reduction by the dependent TPC accumulator (not standalone but dependent from the reference TPC accumulator). The dependent TPC accumulator (e.g., the second TPC accumulator) may update the corresponding power accumulation level (but not for the reference TPC accumulator) based on receiving the TPC command indicating the dependent TPC accumulator. This may imply that the operation (e.g., the UL transmission) on the non-SBFD symbol type is the default symbol type, such that the TPC command for the second TPC accumulator (e.g. the dependent TPC accumulator) is (only) applied for the corresponding TPC accumulator (e.g. the dependent TPC accumulator).

The WTRU may receive the first UL grant scheduling the first UL channel (e.g., the PUSCH, the PUCCH, the SRS, and/or the PRACH) to be transmitted on the first one or more symbols of the first symbol type (e.g., the one or more non-SBFD symbols). The WTRU may transmit the first UL channel using transmit power determined based on the first TPC accumulator (e.g., n1+C1). The WTRU may (also) determine the transmit power based on at least one of the first and/or second set of PC parameters, such as but not limited to P0, P_offset, alpha, and/or PL RS etc., for example.

The WTRU may receive the second UL grant scheduling the second UL channel (e.g., the PUSCH, the PUCCH, the SRS, and/or the PRACH etc.) to be transmitted on the second one or more symbols of the second symbol type (e.g., the one or more SBFD symbols). The WTRU may transmit the second UL channel using transmit power determined based on the second TPC accumulator (e.g., n2+C1+C2 as being dependent on the first TPC accumulator). The WTRU may (also) determine the transmit power based on at least one of the second set of PC parameters, such as but not limited to one or more of P0, P_offset, alpha, and/or PL RS etc., for example, some of which may be the same as (e.g., linked to and/or shared with) those of the first set of PC parameters on the condition that the dependency is on the first TPC accumulator.

In an example, the WTRU may receive a dynamic PC reset command, indication, and/or signal associated with the dependent TPC accumulator (e.g., the second TPC accumulator). The dynamic PC reset command, indication, and/or signal may be associated with the dependent TPC accumulator and/or may be in relation to the current value (i.e. the accumulation level) of the corresponding reference TPC accumulator. The dynamic PC reset command, indication, and/or signal may be received by way of the TPC command and/or by a separate signaling (e.g. by the DCI and/or the MAC CE etc.), and/or may be based on a temporal (e.g., one-time) absolute TPC command for resetting the accumulation level by applying an indicated ratio Q (e.g., Q=+6 dB) with respect to the current accumulation level of the reference TPC accumulator (e.g., the first TPC accumulator). This may provide benefits in terms of increased flexibility and reliability in managing power control by the network, e.g., based on resetting the value of the dependent TPC accumulator by the indicated absolute ratio with respect to the current value of the reference TPC accumulator, e.g., when the current and/or exact power accumulation level for the dependent TPC accumulator is not known (and/or not exactly known) by the network due to any ambiguous conditions such as but not limited to potential misdetection of the one or more TPC commands at the WTRU, etc.

In an example, if the current value (i.e. the accumulation level) of the first TPC accumulator is A1 (e.g., n1+C1) and/or if the WTRU receives the temporal absolute TPC command associated with the dependent TPC accumulator (e.g., the second TPC accumulator) by the indicated ratio of Q, the WTRU may reset (and/or the WTRU may be configured to reset) the value (i.e. the accumulation level) of the second TPC accumulator (i.e. the dependent TPC accumulator) to be A1+Q (e.g., in dB) immediately (and/or after a time duration based on a rule and/or one or more offset parameters etc.). After this, the WTRU may continue receiving the one or more TPC commands and follow the TPC update (e.g., the accumulation) behavior based on an interpretation (e.g. according to the associated CL-index #1 and/or the CL-index #2) as above.

In an example, for a case when the physical UL channel (e.g., the PUSCH and/or the PUCCH, etc.) being scheduled and/or configured is spanned across both the symbol types (e.g., in the slot), the WTRU may receive the indication and/or configuration (explicitly) to follow which symbol type, e.g., including whether to apply the dependent TPC accumulator (across both symbol types). In an example, the WTRU may receive the indication and/or the configuration (explicitly) to follow which symbol type, e.g., including whether to apply the dependent TPC accumulator (across both the symbol types). In an example, the WTRU may (implicitly) determine whether to apply the dependent TPC accumulator depending on the ratio of a number of symbols of each symbol type (e.g., in the slot).

In an example, for a case when a PC setting is associated with a beam reference (e.g., the TCI state and/or an indicated TCI state under the unified TCI framework), the WTRU may receive the indication and/or the configuration that the one or more TCI states (e.g., the one or more activated and/or indicated TCI-states etc.) are associated with the first and/or second sets of PC parameters. In an example, the WTRU may receive an indication and/or configuration (and/or the WTRU may determine) that the one or more TCI states (e.g., the one or more activated and/or indicated TCI states etc.) are associated with the first and/or second TPC accumulators.

In an example, the WTRU may receive the first UL grant scheduling the first UL channel (e.g., the PUSCH, the PUCCH, the SRS, and/or the PRACH) to be transmitted by using the first TCI state (e.g., wherein at least the first set of PC parameters is associated) and/or to be transmitted on the first symbol type (e.g., the one or more non-SBFD symbols). The WTRU may transmit the first UL channel based on the first TCI state and using transmit power determined based on the first TPC accumulator (and/or at least one of the first set of PC parameters).

The WTRU may receive a second UL grant scheduling the second UL channel (e.g., the PUSCH, the PUCCH, the SRS, and/or the PRACH etc.) to be transmitted by using the first TCI state and on the second symbol type (e.g., the one or more SBFD symbols). The WTRU may determine that the first TCI state is associated with the second TPC accumulator (e.g., the dependent TPC accumulator), e.g., due to the fact that the second UL channel is to be transmitted on the second symbol type, and may transmit the second UL channel based on the first TCI state and using transmit power determined based on the second TPC accumulator (e.g. the dependent TPC accumulator) (and at least one of the second set of PC parameters), e.g., where the reference TPC accumulator is the first TPC accumulator that is associated with the first TCI-state.

In an example, for a case when the WTRU maintains more than one non-SBFD TPC accumulators, the WTRU may receive the configuration and/or indication of (e.g., for use in the one or more non-SBFD symbols) the first set of PC parameters and the second set of PC parameters.

The first set of PC parameters may include but are not limited to one or more of: PC-MAX, P0, P_offset, alpha, the PL RS, and/or the first CL index (i.e. the CL-index #1) etc., where the WTRU may determine the UL Tx power level (P) based on the first set of PC parameters, e.g., on the given time (e.g. the transmission occasion) i,

P(i)=P0+P_offset (i)+alpha*PL(i) (estimated by the PL RS)+the value of the first TPC accumulator (with the initial value of n1) associated with the CL-index #1.

The second set of PC parameters which may include but are not limited to PC-MAX, P0, P_offset, alpha, the PL RS, and/or the second CL index (i.e. the CL-index #2) etc., where the CL-index #2 is associated with the second TPC accumulator (with the initial value of n2).

The WTRU may receive the configuration of (e.g., for use in SBFD symbols) the third set of PC parameters. The third set of PC parameters which may comprise one or more of: PC-MAX, P0, P_offset, alpha, the PL RS, and/or a third CL index (i.e. the CL-index #3) etc., where the CL-index #3 is associated with the third TPC accumulator (with the initial value of n3)

The WTRU may receive the indication (and/or the WTRU may implicitly determines) that the third TPC accumulator is dependent on the reference TPC accumulator which may be at least one of the first and/or second TPC accumulators. In an example, the initial value of n3 may be the same as n1 or n2, when the third TPC accumulator is configured to be dependent on the first and/or second TPC accumulators, respectively. In an example, on or more of the following parameters: P0, P_offset, alpha, and/or the PL RS of the third set of PC parameters may be configured to be same (common) as those of the first and/or second set of PC parameters that corresponds to the reference TPC accumulator.

The WTRU may receive the first TPC command (e.g., by the DCI) indicating the CL-index #1 and the first value (C1 in dB). In response to the first TPC command, the WTRU may update the value (e.g., the accumulation level) of the first TPC accumulator to be n1+C1, and on the condition that the WTRU determines the third TPC accumulator is dependent on the first TPC accumulator (e.g. as the reference TPC accumulator) associated with the CL-index #1, the value (e.g., the accumulation level) of the third TPC accumulator to be n3+C1.

The WTRU may receive the second TPC command (e.g., by the DCI) indicating the CL-index #2 and the second value (C2 in dB). In response to the second TPC command, the WTRU may update the value (e.g., the accumulation level) of the second TPC accumulator to be n2+C2, on condition that the WTRU determines the third TPC accumulator is dependent on the second TPC accumulator but not the first TPC accumulator, the value of the third TPC accumulator to be n3+C2, and on condition that the WTRU determines the third TPC accumulator is dependent on both the first and second TPC accumulators, the value of the third TPC accumulator to be n3+C1+C2.

The WTRU may receive the third TPC command (e.g., by the DCI) indicating the CL-index #3 and the third value (C3 in dB). In response to the third TPC command, the WTRU may update (e.g., only update) the third TPC accumulator to be the current value (e.g., n3+C1, and/or n3+C2, and/or n3+C1+C2 etc.) plus C3, and may maintain the value of the first TPC accumulator as n1+C1 and/or maintain the value of the second TPC accumulator as n2+C2.

The WTRU may receive the first UL grant scheduling the first UL channel (e.g., the PUSCH, the PUCCH, the SRS, and/or the PRACH etc.) to be transmitted on the first one or more symbols of the first symbol type (e.g., the one or more non-SBFD symbols). The WTRU may transmit the first UL channel using transmit power determined based on the first and/or second TPC accumulators (e.g., n1+C1 and/or n2+C2). The WTRU may also determine the transmit power based on at least one of the first and/or second set of PC parameters such as but not limited to P0, P_offset, alpha, and/or the PL RS.

The WTRU may receive the second UL grant scheduling the second UL channel (e.g., the PUSCH, the PUCCH, the SRS, and/or the PRACH) to be transmitted on the second one or more symbols of the second symbol type (e.g., the one or more SBFD symbols). The WTRU may transmit the second UL channel using the transmit power determined based on the third TPC accumulator (e.g., n3+C1+C3 if dependent on the first TPC accumulator, and/or n3+C2+C3 if dependent on the second TPC accumulator, and/or n3+C1+C2+C3 if dependent on both the first and second TPC accumulators etc.). The WTRU may also determine the transmit power based on at least one of the third set of PC parameters such as but not limited to one or more of the P0, P_offset, alpha, and/or the PL RS, some of which may be the same as (e.g., linked to and/or shared with) those of the first set of PC parameters when the dependency is on the first TPC accumulator, and/or the second set of PC parameters when the dependency is on the second TPC accumulator, for example.

In an example, the WTRU may utilize separate PC for the SBFD symbol type and the non-SBFD symbol type per TCI state. In an example, the WTRU may receive the one or more configurations and/or the one or more indications of a plurality of PC parameter sets that may be configured for the TCI state (and/or multiple TCI states etc.). The PC parameter set of the multiple PC parameter sets may include but is not limited to one or more of: PC-MAX, P0, alpha, the PL RS, the CL index, and/or the P_offset etc., for example. The first PC parameter set of the multiple PC parameter sets may be associated with the first symbol type (e.g., the non-SBFD symbol type and/or an (in-band) non-FD symbol type etc.). The second PC parameter set of the multiple PC parameter sets may be associated with the second symbol type (e.g., the SBFD symbol type and/or an (in-band) FD symbol type). In an example, the WTRU may receive the TCI related configurations, including but not limited to the plurality of TCI states (e.g., the RRC configured pool of TCI-states (e.g., as the unified TCI framework), the TCI state IE, the TCI UL state IE, the spatialRelationInfo IE, etc.). The TCI state of the plurality of TCI states may be associated with and/or include the multiple PC parameter sets (e.g., the PathlossReferenceRS-ID-Second and/or the UL-PowerControl-Second) in addition to at least one of QCL-info #1 and/or QCL-info #2. The QCL-info #1 and/or QCL-info #2 may include but are not limited to the cell ID (e.g., the serving cell index), the BWP ID, the RS (e.g., the CSI RS and/or the SSB index), and/or the QCL type which may be one or more of typeA, typeB, typeC, and/or typed etc., for example.

In an example, the multiple PC parameter sets associated with the TCI state may be given as follows:

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

```
  ...,
  [[
```

| | |
|---|---|
| additionalPCI-r17 | AdditionalPCIIndex-r17 OPTIONAL, -- Need R |
| pathlossReferenceRS-Id-r17 | PathlossReferenceRS-Id-r17 OPTIONAL, -- Cond |

JointTCI1

| | |
|---|---|
| pathlossReferenceRS-Id-second | PathlossReferenceRS-Id-second OPTIONAL, -- |

Cond JointTCI1

| | |
|---|---|
| ul-powerControl-r17 | Uplink-powerControlId-r17 OPTIONAL -- Cond |

JointTCI

| | |
|---|---|
| ul-powerControl-second | Uplink-powerControlId-second OPTIONAL -- |

```
Cond JointTCI
  ]],
  [[
```

| | |
|---|---|
| tag-Id-ptr-r18 | ENUMERATED {n0,n1} OPTIONAL -- Cond |

2TA
]]
}

In an example, the WTRU may operate (and/or the WTRU may be configured to operate) as Mode A for separating PC across the different symbol types, e.g., without separating spatial-domain parameter setting (e.g., based on the one or more TCI states etc.) across the different symbol types. In an example, when the first TCI state (e.g., TCI #3) (that is associated with the first PC parameter set and/or the second PC parameter set) is indicated (by the TCI field of the DCI, illustrated in FIG. 4), the WTRU may determine two (different and/or separated) UL transmission power, e.g., one based on the first PC parameter set and the second PC parameter set. For the UL transmission scheduled (and/or configured), the WTRU may determine which PC parameter set to use for, based on the explicit indication by the gNB (e.g., by the DCI) and/or an implicit determination, based on at least one of following conditions. In a condition, the WTRU may determine whether the UL Tx occurs on the one or more non-SBFD symbols or on the one or more SBFD symbols. If the UL Tx occurs on the one or more non-SBFD symbols, the WTRU may apply the first PC parameter set for determining the UL Tx power for the UL Tx. If the UL Tx occurs on the SBFD symbols, the WTRU may apply the second PC parameter set for determining the UL Tx power for the UL Tx.

In an example, as the default behavior, the first PC parameter set (e.g., for the non-SBFD symbol type) may be used as the default parameter set and/or as the one or more default parameters (e.g., the value ‘0’ of the explicit indicator in the DCI). If the value ‘1’ is indicated, the second PC parameter set (e.g., for the SBFD symbol type) may be used as the default parameter set and/or as the one or more default parameters.

In an example, the first TPC accumulator (e.g., associated with the first CL index of the first PC parameter set) may be used as the default (e.g., the value ‘0’ of the explicit indicator in the DCI). If the value ‘1’ is indicated, the second TPC accumulator (e.g., associated with the second CL index of the second PC parameter set) may be used. For example, at least one of other PC related parameters (e.g., P0, alpha, the PL RS, and/or P_offset etc.) may be commonly used for any (e.g., each) case, e.g., used from the first (and/or second) PC parameter set.

In an example, the WTRU may determine (and/or the WTRU may be configured to determine) which PC parameter set (and/or which TPC accumulator for the closed loop PC is the accumulative TPC) to be used for the UL transmission (e.g., in the one or more corresponding transmission occasions), where the WTRU may determine (e.g., pick and/or select) one with (e.g., showing, representing, and/or resulting in) a higher power (and/or a lower power) in the one or more transmission occasions.

In an example, the WTRU may determine one or more conditions based on a time-domain gap between the one or more SBFD symbols and the one or more non-SBFD symbols. Based on one or more pre-defined and/or configured conditions, e.g., related to the time-domain gap between the one or more SBFD symbols and the one or more non-SBFD symbols, the WTRU may determine and/or may be configured to determine which PC parameter set (e.g., which TPC accumulator) to be used for the UL transmission. In an example, if the time domain gap between the one or more SBFD symbols and the one or more non-SBFD symbols (e.g., of the scheduled and/or configured UL Tx, and/or based on the SBFD time domain sub-bands location information) is smaller than a first threshold the WTRU may determine to use the first PC parameter set (e.g., the first TPC accumulator) for the UL Tx (e.g., for all (and/or the subset) of the scheduled and/or configured UL Tx occasions). If the time domain gap is larger than the first threshold (e.g., and smaller than the second threshold), the WTRU may determine to use the second PC parameter set (e.g., the second TPC accumulator) for the UL Tx. In a generalized example, if the time domain gap is larger than a second threshold (e.g., and smaller than a third threshold), the WTRU may determine to use the third PC parameter set (e.g., the third TPC accumulator) for the UL Tx. In an example, the time domain gap may be semi-statically configured and/or dynamically indicated and/or selected etc., for example.

In an example, the WTRU may operate and/or may be configured to operate as Mode B for separating both the PC and the beam control (e.g., based on the TCI states) across the different symbol types. In an example, when the first TCI state (e.g., TCI #3, that is associated with both the first and second PC parameter sets, illustrated in FIG. 5) is indicated (e.g. by the TCI field of the DCI, illustrated in FIG. 4), the WTRU may determine whether the first TCI state is associated with the non-SBFD symbol type or the SBFD symbol type. If the WTRU determines that the indicated first TCI state is for the non-SBFD symbol type, the WTRU may apply (e.g., maintain and/or use etc.) the first TCI state and the first PC parameter set that is selected, e.g., at least the first TPC accumulator to be used for the UL Tx on the non-SBFD symbols. If the WTRU determines the indicated first TCI state is for the SBFD symbol type, the WTRU may apply (e.g., maintain and/or use) the first TCI state and the second PC parameter set that is selected, e.g. at least the second TPC accumulator to be used for the UL Tx on the one or more SBFD symbols.

In an example (e.g., generalized example), the WTRU may receive the indication (e.g., by the DCI) of the second TCI state (that may be associated with the third PC parameter set and the fourth PC parameter set) where the second TCI state may be the indicated TCI state to be used for multiple channels and/or signals commonly under the unified TCI framework. If the WTRU determines the indicated second TCI state is for the non-SBFD symbol type, the WTRU may apply (e.g., maintain by updating any previous indicated TCI state and/or PC in the same symbol type and/or use) the second TCI state and/or the third PC parameter set that is selected, e.g. at least the third TPC accumulator to be used for the UL Tx on the one or more non-SBFD symbols. If the WTRU determines the indicated second TCI state is for the SBFD symbol type, the WTRU may apply (e.g., maintain by updating any previous indicated TCI state and/or the PC in the same symbol type and/or use) the second TCI state and the fourth PC parameter set that is selected, e.g., at least the fourth TPC accumulator to be used for the UL Tx on the one or more SBFD symbols.

In an example, the WTRU may determine and/or may be configured to determine the second PC parameter set has (e.g., comprise, imply, and/or indicate) a delta power-offset parameter (e.g., P0_offset and/or P_offset) to be added on the determined (e.g., calculated and/or derived) transmission power level based on the first PC parameter set. In an example, the WTRU may determine the UL Tx power of the scheduled and/or configured UL Tx, e.g., on the one or more SBFD symbols, as the power value (e.g. the level) determined by the first PC parameter set plus the delta (e.g., P0_offset and/or P_offset). The delta power offset parameter (e.g., to be applied as the part of the second PC parameter set) may be common for all (and/or the subset) of the one or more configured TCI states. The delta power offset parameter (e.g., to be applied as the part of the second PC parameter set) may be common for all (and/or the subset) of the one or more activated TCI states (e.g., activated by the MAC CE and/or the TCI activation MAC CE etc.). The delta power offset parameter (e.g., to be applied as the part of the second PC parameter set) may be configured and/or indicated for the set of TCI states (and/or per TCI state) (e.g., via the RRC and/or the MAC CE, e.g., the TCI activation MAC CE etc.).

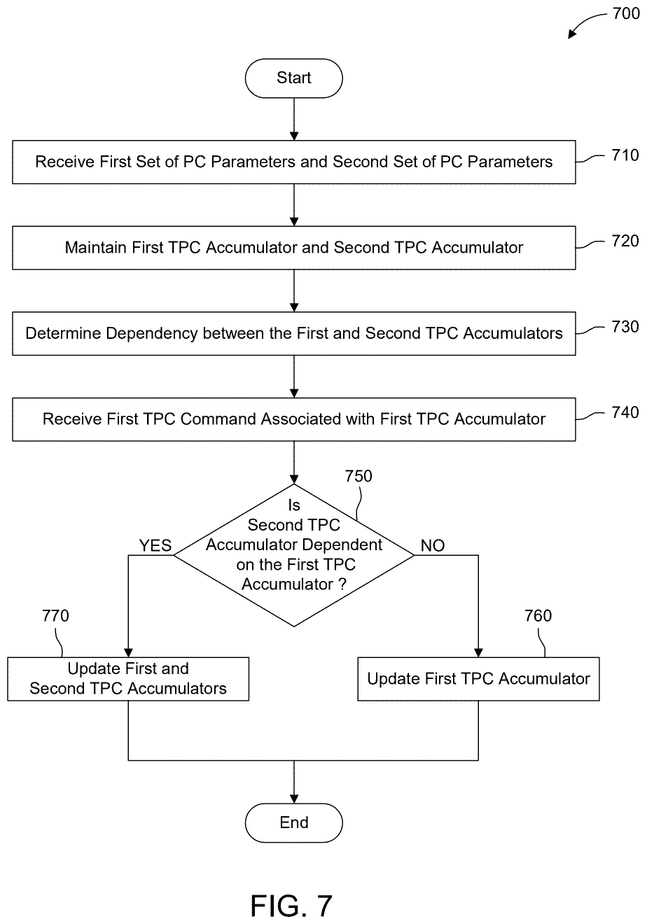

FIG. 7 is a flowchart illustrating an example process 700 for updating the separate TPC buffers according to an embodiment. The process 700 may be implemented by the WTRU. At 710, the WTRU receives the first set of PC parameters and the second set of PC parameters. In an example, the WTRU receives the configuration including the first set of PC parameters and the second set of PC parameters. The first set of PC parameters (e.g., for use in the one or more non-SBFD symbols) may comprise but are not limited to at least one of P0, P_offset, alpha, a PL RS, and/or the first CL index (i.e. the CL-index #1) etc., for example. The parameters P0, P_offset, alpha, and/or the PL RS, may be utilized for the open loop PC. That is, the parameters P0, P_offset, alpha, and/or the PL RS may be the open loop parameters. The first CL index (i.e. the CL-index #1) may be associated with the first TPC accumulator. The first TPC accumulator may have the initial value of n1. The first CL index (i.e. the CL-index #1) may be utilized for the closed loop PC. That is, the first CL index (i.e. the CL-index #1) may be a closed loop PC parameter. In an example, the second set of PC parameters (e.g., for use in the one or more SBFD symbols) may comprise but are not limited to at least one of P0, P_offset, alpha, a PL RS, the second CL index (i.e. the CL-index #2) etc., for example. That is, the parameters P0, P_offset, alpha, and/or the PL RS may be the open loop parameters, and hence, may be the same as (and/or common to) the first set of PC parameters. The second CL index (i.e. the CL-index #2) may be associated with the second TPC accumulator. The second TPC accumulator may have the initial value of n2. The second CL index (i.e. the CL-index #2) may be utilized for the closed loop PC. That is, the second CL index (i.e. the CL-index #2) may be the closed loop PC parameter. In an example, the initial value of n2 may be the same as n1, when the second TPC accumulator is configured to be dependent on the first TPC accumulator. In an example, at least one of the open loop PC parameters such as but not limited to P0, P_offset, alpha, and/or the PL RS of the second set of PC parameters (that correspond to the dependent TPC accumulator) may be configured to be same (and/or common) as those of the first set of PC parameters (that correspond to the reference TPC accumulator).

At 720, the WTRU maintains the first TPC accumulator and the second TPC accumulator. In an example, the WTRU stores the first TPC accumulator and the second TPC accumulator in the memory, for example, in form of one or more buffers. The WTRU may dynamically and/or periodically update the first TPC accumulator and/or the second TPC accumulator based on the one or more TPC commands. The first TPC accumulator may have the first accumulator level (e.g. the value of the first TPC accumulator). The second TPC accumulator may have the second accumulator level (e.g. the value of the second TPC accumulator). Updating the first TPC accumulator and/or the second TPC accumulator may include incrementing and/or decrementing the first and/or second accumulator levels respectively.

At 730, the WTRU determines the dependency between the first and second TPC accumulators. In an example, the WTRU receives the indication (and/or the WTRU may implicitly determine) that the second TPC accumulator (e.g., the one or more SBFD TPC accumulators) is dependent on the reference TPC accumulator which may be the first TPC accumulator (e.g., the one or more non-SBFD TPC accumulators). In case of more than one non-SBFD TPC accumulators (e.g., the first TPC accumulator and the third TPC accumulator for use in the one or more non-SBFD symbols) associated with the SBFD TPC accumulator, the WTRU may receive the indication and/or the configuration indicating and/or identifying the set of non-SBFD TPC accumulators that are associated and/or linked to the SBFD TPC accumulator. In an example, the WTRU may receive the indication that the second TPC accumulator is dependent on (e.g. selectively dependent on) the first TPC accumulator and/or the third TPC accumulator.

At 740, the WTRU receives the first TPC command associated with the first TPC accumulator. The WTRU may receive the first TPC command by the DCI etc. indicating the first CL index (i.e. the CL-index #1) and the first value (C1 in dB).

At 750, the WTRU checks whether the second TPC accumulator is dependent on the first TPC accumulator. In an example, the WTRU may check for the dependency based on the received indication. In another example, the WTRU may implicitly determine the dependency without requiring the explicit indication. This may be done, for example, based on one or more rules, the symbol types, the uplink channel types, the resource grant types, and/or the communication schemes (e.g. SBFD and/or non-SBFD) etc.

If the WTRU determines that the second TPC accumulator is not dependent on the first TPC accumulator, at 760, the WTRU only updates the first TPC accumulator based on the first TPC command.

If the WTRU determines that the second TPC accumulator is dependent on the first TPC accumulator, at 770, the WTRU updates the first TPC accumulator and the second TPC accumulator based on the first TPC command.

In an example, to update the first and second TPC accumulators based on the first TPC command, the WTRU may increment and/or decrement the first value (indicated by the first TPC command) to/from the first and second accumulator levels respectively.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented by a wireless transmit/receive unit (WTRU), the method comprising:
receiving, from a base station, configuration information including a first set of parameters associated with a first transmit power control (TPC) accumulator and a second set of parameters associated with a second TPC accumulator, wherein the second TPC accumulator is dependent on the first TPC accumulator, and wherein the second TPC accumulator is associated with a sub-band full duplex (SBFD) transmission and the first TPC accumulator is associated with a non-SBFD transmission;
receiving, from the base station, a first TPC command associated with the first TPC accumulator; and
updating the first TPC accumulator and the second TPC accumulator based on the first TPC command.

2. The method of claim 1, further comprising:
receiving a second TPC command associated with the second TPC accumulator; and
updating the second TPC accumulator based on the second TPC command.

3. The method of claim 2, wherein updating the first TPC accumulator comprises incrementing a first accumulation level associated with the first TPC accumulator by a first value indicated by the first TPC command.

4. The method of claim 3, further comprising:
maintaining the first TPC accumulator at the first accumulation level upon receiving the second TPC command.

5. The method of claim 3, wherein updating the second TPC accumulator comprises incrementing a second accumulation level associated with the second TPC accumulator by one or more of: the first value indicated by the first TPC command or a second value indicated by the second TPC command.

6. The method of claim 5, wherein a first step-size associated with the first TPC command is different from a second step-size associated with the second TPC command.

7. The method of claim 1, further comprising:
initializing the first TPC accumulator and the second TPC accumulator to a common initial accumulation level.

8. The method of claim 1, wherein the first set of parameters and the second set of parameters comprise at least one of:
one or more common open loop power control parameters, or
respective first and second closed loop indexes associated with the first and second TPC accumulators.

9. The method of claim 2, wherein the first TPC command and the second TPC command comprise respective first and second closed loop indexes associated with the first and second TPC accumulators.

10. The method of claim 1, further comprising:
on a condition that an uplink grant scheduling an uplink channel transmission on one or more SBFD symbols is received from the base station,
determining a transmit power level based on the second TPC accumulator; and
transmitting, to the base station, the uplink channel transmission on the one or more SBFD symbols at the determined transmit power level.

11. A wireless transmit/receive unit (WTRU), comprising:
a memory configured to store a first transmit power control (TPC) accumulator and a second TPC accumulator;
a transceiver configured to:
receive, from a base station, configuration information including a first set of parameters associated with the first TPC accumulator and a second set of parameters associated with the second TPC accumulator, wherein the second TPC accumulator is dependent on the first TPC accumulator, and wherein the second TPC accumulator is associated with a sub-band full duplex (SBFD) transmission and the first TPC accumulator is associated with a non-SBFD transmission, and
receive, from the base station, a first TPC command associated with the first TPC accumulator; and
a processor configured to update the first TPC accumulator and the second TPC accumulator based on the first TPC command.

12. The WTRU of claim 11, wherein the transceiver is further configured to:
receive a second TPC command associated with the second TPC accumulator; and
update the second TPC accumulator based on the second TPC command.

13. The WTRU of claim 12, wherein the processor is further configured to:
increment a first accumulation level associated with the first TPC accumulator by a first value indicated by the first TPC command, to update the first TPC accumulator.

14. The WTRU of claim 13, wherein the processor is further configured to:
maintain the first TPC accumulator at the first accumulation level upon receiving the second TPC command.

15. The WTRU of claim 13, wherein the processor is further configured to:
increment a second accumulation level associated with the second TPC accumulator by one or more of: the first value indicated by the first TPC command or a second value indicated by the second TPC command, to update the second TPC accumulator.

16. The WTRU of claim 11, wherein the processor is further configured to:
initialize the first TPC accumulator and the second TPC accumulator to a common initial accumulation level.

17. The WTRU of claim 11, wherein the first set of parameters and second set of parameters comprise one or more common open loop power control parameters.

18. The WTRU of claim 12, wherein the first set of parameters and the second set of parameters comprise respective first and second closed loop indexes associated with the first and second TPC accumulators, and wherein the first TPC command and the second TPC command comprise respective first and second closed loop indexes associated with the first and second TPC accumulators.

19. The WTRU of claim 11, wherein the processor is further configured to:
on a condition that an uplink grant scheduling an uplink channel to be transmitted on one or more SBFD symbols is received from the base station,
determine a transmit power level based on the second TPC accumulator.

20. The WTRU of claim 19, wherein the transceiver is further configured to:
transmit, to the base station, the uplink channel on the one or more SBFD symbols at the determined transmit power level.
